(19) United States
(12) Patent Application Publication
(10) Pub. No.: US 2016/0364888 A1
(43) Pub. Date: Dec. 15, 2016

(54) IMAGE DATA PROCESSING METHOD AND ELECTRONIC DEVICE SUPPORTING THE SAME

(71) Applicant: Samsung Electronics Co., Ltd., Suwon-si (KR)

(72) Inventors: Kwang Ha JEON, Namyangju-si (KR); Min Jee JOU, Yongin-si (KR); Ji Hye MYUNG, Seoul (KR)

(21) Appl. No.: 15/177,815

(22) Filed: Jun. 9, 2016

(30) Foreign Application Priority Data
Jun. 9, 2015 (KR) 10-2015-0081477

(51) Int. Cl. G06T 11/00; G06F 3/0488; G09G 3/20

(52) U.S. Cl. CPC G06T 11/001; G09G 3/2003; G06F 3/0488; G09G 2320/0666

(57) ABSTRACT

An electronic device is provided. The electronic device includes a display, a processor electrically connected with the display, and a memory electrically connected with the processor. The memory includes instructions, which, when executed by the processor, cause the processor to change a first image such that the first image including a first amount of data is changed to include a second amount of data that is less than the first amount of data, extract at least one dominant color of at least one partial area of the changed first image, perform a gradient in the at least one partial area of the changed first image based on the extracted at least one dominant color, and control the display to display a second image including the at least one partial area to which the gradient is applied on at least one part of the display.

### CROSS-REFERENCE TO RELATED APPLICATION(S)

This application claims the benefit under 35 U.S.C. §119(a) of a Korean patent application filed on Jun. 9, 2015 in the Korean Intellectual Property Office and assigned Serial number 10-2015-0081477, the entire disclosure of which is hereby incorporated by reference.

### TECHNICAL FIELD

The present disclosure relates to a method for processing image data.

### BACKGROUND

There are various methods for filling a designated area of a screen with at least one color. In particular, to display contents (e.g., a text, an image, a video, an icon, a symbol, or the like) on the screen, a method for representing colors by mixing various colors is used as a method for filling a background area of the contents and an area adjacent to the contents. For example, a gradient method is used which includes mixing a plurality of colors and filling the designated area of the screen with the mixed color. Furthermore, a method for extracting a dominant color about the contents is used as a method for selecting the plurality of colors.

In the method of the related art for extracting a dominant color, all pixels of an area on which the contents are displayed are found, and the most used color is designated as a dominant color. In this case, the performance depends on a size of an area on which the contents are displayed. Furthermore, in the case of applying the gradient method of the related art with regard to vertices of which a number exceeds a designated value (e.g., four), the gradient method of the related art does not smoothly represent a color in a designated area of a screen. For example, a cracking phenomenon may be generated.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an image data processing method for extracting a dominant color and an electronic device supporting the same.

In accordance with an aspect of the present disclosure, an electronic device is provided. The electronic device includes a display, a processor electrically connected with the display, and a memory electrically connected with the processor. The memory includes instructions, which, when executed by the processor, cause the processor to change a first image such that the first image including a first amount of data is changed to include a second amount of data that is less than the first amount of data, extract at least one dominant color of at least one partial area of the changed first image, perform a gradient in the at least one partial area of the changed first image based on the extracted at least one dominant color, and control the display to display a second image including the at least one partial area to which the gradient is applied on at least one part of the display.

In accordance with another aspect of the present disclosure, an electronic device is provided. The electronic device includes a display, a processor electrically connected with the display, and a memory electrically connected with the processor. The memory includes instructions, which, when executed by the processor, instruct the processor to generate a second image that includes a first image stored in the memory and a peripheral area that encompasses at least a part of the first image, perform a first gradient in a third area of the peripheral area adjacent to a first area of the first image based on a first dominant color of the first area, perform a second gradient in a fourth area of the peripheral area adjacent to a second area of the first image based on a second dominant color of the second area, and display the second image, in which the first gradient and the second gradient are performed, on at least a part of the display.

In accordance with another aspect of the present disclosure, a method for processing image data of an electronic device is provided. The method includes changing a first image such that the first image including a first amount of data is changed to include a second amount of data that is less than the first amount of data, extracting at least one dominant color of at least one partial area of the changed first image, performing a gradient in the at least one partial area of the changed first image based on the extracted at least one dominant color, and displaying a second image including the at least one partial area to which the gradient is applied on at least one part of the display.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view illustrating an electronic device associated with image data processing according to various embodiments of the present disclosure;

FIG. 2 is a view illustrating an image data processing module according to various embodiments of the present disclosure;

FIG. 3 is a view illustrating architecture of modules that are associated with image data processing and operate when executing a designated application according to various embodiments of the present disclosure;

FIG. 4 is a view for describing a method for generating a gradient image using a reference image according to various embodiments of the present disclosure;

FIG. 5 is a flowchart illustrating an operation method of an electronic device associated with a method for generating a gradient image using a reference image according to various embodiments of the present disclosure;

FIG. 6 is a view for describing a method for extracting a gradient direction according to various embodiments of the present disclosure;

FIG. 7A is a view for describing a radial gradient effect of gradient effects according to various embodiments of the present disclosure;

FIG. 7B is a view for describing a mesh gradient effect of gradient effects according to various embodiments of the present disclosure;

FIG. 7C is a view for describing a blur gradient effect of gradient effects according to various embodiments of the present disclosure;

FIG. 8 is a view for describing color modification according to various embodiments of the present disclosure;

FIG. 9 is a flowchart illustrating an operation method of an electronic device associated with color modification according to various embodiments of the present disclosure of the present disclosure;

FIG. 10A is a separated perspective view of layers for describing a method for applying a gradient image for each layer according to various embodiments of the present disclosure;

FIG. 10B is a view illustrating the layers of FIG. 10A combined according to various embodiments of the present disclosure;

FIG. 11A is a view for describing a method for applying a gradient effect to a designated screen element according to various embodiments of the present disclosure;

FIG. 11B is a view for describing a method for applying a gradient effect to a designated another screen element according to various embodiments of the present disclosure;

FIG. 12A is a view for describing a method for applying a gradient effect to a partial area of a screen according to various embodiments of the present disclosure;

FIG. 12B is a view for describing another method for applying a gradient effect to a partial area of the screen according to various embodiments of the present disclosure;

FIG. 13 is a view for describing a gradient effect applied when executing a designated application according to various embodiments of the present disclosure;

FIG. 14A is a view for describing a size or shape of a target area according to various embodiments of the present disclosure;

FIG. 14B is a view for describing a method for modifying a gradient image based on the size or shape of the target area and for applying the modified gradient image according to various embodiments of the present disclosure;

FIG. 15 is a view of a screen on which a gradient image is modified according to a size or shape of a target area when executing a designated application according to various embodiments of the present disclosure;

FIG. 16 is a view for describing a method for utilizing a gradient image specified for each user according to various embodiments of the present disclosure;

FIG. 17 is a view for describing a method for utilizing a gradient image when loading a reference image according to various embodiments of the present disclosure;

FIG. 18 is a view for describing a method for utilizing a gradient image when switching a designated screen according to various embodiments of the present disclosure;

FIG. 19 is a view for describing a method for utilizing a gradient image in response to a designated state of an electronic device according to various embodiments of the present disclosure;

FIG. 20 is a view for describing a method for utilizing a gradient image when outputting contents transmitted/received in real time on a screen according to various embodiments of the present disclosure;

FIG. 21 is a block diagram illustrating an electronic device according to various embodiments of the present disclosure; and

FIG. 22 is a block diagram of a program module according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the disclosure disclosed herein, the expressions “have”, “may have”, “include” and “comprise”, or “may include” and “may comprise” used herein indicate existence of corresponding features (e.g., elements such as numeric values, functions, operations, or components) but do not exclude presence of additional features.

In the disclosure disclosed herein, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used herein may refer to various elements of various embodiments of the present disclosure, but do not limit the elements. For example, “a first user device” and “a second user device” may indicate different user devices regardless of the order or priority thereof. For example, without departing the scope of the present disclosure, a first element may be referred to as a second element, and similarly, a second element may be referred to as a first element.

It will be understood that when an element (e.g., a first element) is referred to as being “(operatively or communicatively) coupled with/to” or “connected to” another element (e.g., a second element), it can be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

According to the situation, the expression “configured to” used herein may be used as, for example, the expression “suitable for”, “having the capacity to”, “designed to”, “adapted to”, “made to”, or “capable of”. The term “configured to” must not mean only “specifically designed to” in hardware. Instead, the expression “a device configured to” may mean that the device is “capable of” operating together with another device or other components. For example, a “processor configured to (or set to) perform A, B, and C” may mean a dedicated processor (e.g., an embedded processor) for performing a corresponding operation or a generic-purpose processor (e.g., a central processing unit (CPU) or an application processor (AP)) which performs corresponding operations by executing one or more software programs which are stored in a memory device.

All the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the present disclosure. In some cases, even if terms are terms which are defined in the specification, they may not be interpreted to exclude various embodiments of the present disclosure.

For example, an electronic device according to various embodiments of the present disclosure may include at least one of smartphones, tablet personal computers (PCs), mobile phones, video telephones, electronic book readers, desktop PCs, laptop PCs, netbook computers, workstations, servers, personal digital assistants (PDAs), portable multimedia players (PMPs), Moving Picture Experts Group (MPEG-1 or MPEG-2) phase 1 or phase 2 audio layer 3 (MP3) players, mobile medical devices, cameras, or wearable devices. According to various embodiments of the present disclosure, a wearable device may include at least one of an accessory type of a device (e.g., a timepiece, a ring, a bracelet, an anklet, a necklace, glasses, a contact lens, or a head-mounted-device (HMD)), one-piece fabric or clothes type of a device (e.g., electronic clothes), a body-attached type of a device (e.g., a skin pad or a tattoo), or a bio-implantable type of a device (e.g., implantable circuit).

According to another embodiment of the present disclosure, the electronic devices may be home appliances. The home appliances may include at least one of, for example, televisions (TVs), digital versatile disc (DVD) players, audios, refrigerators, air conditioners, cleaners, ovens, microwave ovens, washing machines, air cleaners, set-top boxes, home automation control panels, security control panels, TV boxes (e.g., Samsung HomeSync™, Apple TV™, or Google TV™), game consoles (e.g., Xbox™ or PlayStation™), electronic dictionaries, electronic keys, camcorders, electronic picture frames, or the like.

According to another embodiment of the present disclosure, the photographing apparatus may include at least one of medical devices (e.g., various portable medical measurement devices (e.g., a blood glucose monitoring device, a heartbeat measuring device, a blood pressure measuring device, a body temperature measuring device, and the like)), a magnetic resonance angiography (MRA), a magnetic resonance imaging (MRI), a computed tomography (CT), scanners, and ultrasonic devices), navigation devices, global positioning system (GPS) receivers, event data recorders (EDRs), flight data recorders (FDRs), vehicle infotainment devices, electronic equipment for vessels (e.g., navigation systems and gyrocompasses), avionics, security devices, head units for vehicles, industrial or home robots, automatic teller's machines (ATMs), points of sales (POSs), or internet of things (e.g., light bulbs, various sensors, electric or gas meters, sprinkler devices, fire alarms, thermostats, street lamps, toasters, exercise equipment, hot water tanks, heaters, boilers, and the like).

According to another embodiment of the present disclosure, the electronic devices may include at least one of parts of furniture or buildings/structures, electronic boards, electronic signature receiving devices, projectors, or various measuring instruments (e.g., water meters, electricity meters, gas meters, or wave meters, and the like). In the various embodiments of the present disclosure, the electronic device may be one of the above-described various devices or a combination thereof. An electronic device according to an embodiment may be a flexible device. Furthermore, an electronic device according to an embodiment may not be limited to the above-described electronic devices and may include other electronic devices and new electronic devices according to the development of technologies.

Hereinafter, an electronic device according to the various embodiments may be described with reference to the accompanying drawings. In this disclosure, the term “user” may refer to a person who uses an electronic device or may refer to a device (e.g., an artificial intelligence electronic device) that uses an electronic device.

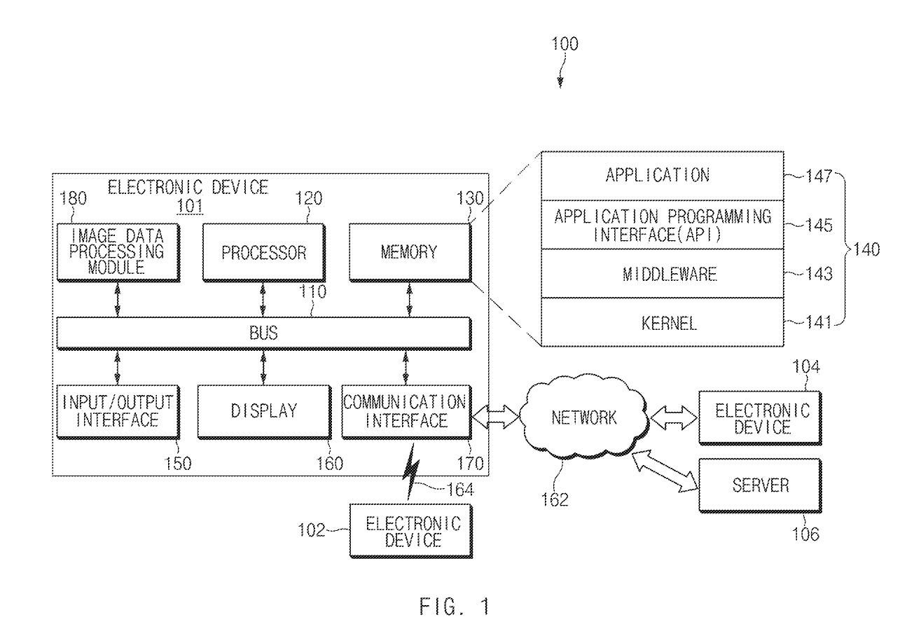

FIG. 1 is a view illustrating an electronic device associated with image data processing according to various embodiments of the present disclosure.

Referring to FIG. 1, there is illustrated an electronic device 101 in a network environment 100 according to various embodiments of the present disclosure. The electronic device 101 may include a bus 110, a processor 120, a memory 130, an input/output (I/O) interface 150, a display 160, a communication interface 170, and an image data processing module 180. According to an embodiment of the present disclosure, the electronic device 101 may not include at least one of the above-described elements or may further include other element(s).

For example, the bus 110 may interconnect the above-described elements (i.e., the bus 110 may interconnect the processor 120, memory 130, I/O interface 150, display 160, communication interface 170, and image data processing module 180) and may include a circuit for conveying communications (e.g., a control message and/or data) among the above-described elements.

The processor 120 may include one or more of a CPU, an AP, and a communication processor (CP). The processor 120 may perform, for example, data processing or an operation associated with control or communication of at least one other element(s) of the electronic device 101. According to various embodiments of the present disclosure, the processor 120 may include at least some of elements of the image data processing module 180 or may perform at least one function of the image data processing module 180.

The memory 130 may include a volatile and/or nonvolatile memory. For example, the memory 130 may store instructions or data associated with at least one other element(s) of the electronic device 101. According to an embodiment of the present disclosure, the memory 130 may store software and/or a program 140. The program 140 may include, for example, a kernel 141, a middleware 143, an application programming interface (API) 145, and/or an application program (or “application”) 147. At least a part of the kernel 141, the middleware 143, or the API 145 may be called an “operating system (OS)”.

The kernel 141 may control or manage system resources (e.g., the bus 110, the processor 120, the memory 130, and the like) that are used to execute operations or functions of other programs (e.g., the middleware 143, the API 145, and the application program 147). Furthermore, the kernel 141 may provide an interface that allows the middleware 143, the API 145, or the application program 147 to access discrete elements of the electronic device 101 so as to control or manage system resources.

The middleware 143 may perform, for example, a mediation role such that the API 145 or the application program 147 communicates with the kernel 141 to exchange data.

Furthermore, the middleware 143 may process one or more task requests received from the application program 147 according to a priority. For example, the middleware 143 may assign the priority, which makes it possible to use a system resource (e.g., the bus 110, the processor 120, the memory 130, or the like) of the electronic device 101, to at least one of the application program 147. For example, the middleware 143 may process the one or more task requests according to the priority assigned to the at least one, which makes it possible to perform scheduling or load balancing on the one or more task requests.

The API 145 may be an interface through which the application program 147 controls a function provided by the kernel 141 or the middleware 143, and may include, for example, at least one interface or function (e.g., an instruction) for a file control, a window control, image processing, a character control, or the like.

According to various embodiments of the present disclosure, the memory 130 may include information, resources, instructions, and the like associated with image data processing. For example, the memory 130 may include an instruction for resizing a reference image to a designated size, an instruction for dividing the resized image into a plurality of areas, an instruction for extracting dominant colors for the respective divided areas, an instruction for modifying the extracted colors, an instruction for generating a gradient image of a designated size using the extracted colors or the modified colors or for applying a gradient effect to a designated image, an instruction for modifying the generated gradient image, or the like. Furthermore, the memory 130 may store at least one of the reference image, the dominant color, and the gradient image associated with the execution of the above-described instructions.

The I/O interface 150 may transmit an instruction or data, input from a user or another external device, to other element(s) of the electronic device 101. Furthermore, the I/O interface 150 may output an instruction or data, received from other element(s) of the electronic device 101, to a user or another external device.

The display 160 may include, for example, at least one of a liquid crystal display (LCD), a light-emitting diode (LED) display, an organic LED (OLED) display, a microelectromechanical systems (MEMS) display, and an electronic paper display. The display 160 may display, for example, various kinds of contents (e.g., a text, an image, a video, an icon, a symbol, and the like) to a user. The display 160 may include a touch screen and may receive, for example, at least one of a touch, gesture, proximity, and hovering input using an electronic pen and/or a portion of a user's body.

The communication interface 170 may establish communication between the electronic device 101 and an external device (e.g., one of a first external electronic device 102, a second external electronic device 104, and a server 106). For example, the communication interface 170 may be connected to a network 162 through wireless communication or wired communication to communicate with an external device (e.g., one of the second external electronic device 104 and the server 106).

The wireless communication may include at least one of, for example, long-term evolution (LTE), LTE-advance (LTE-A), code division multiple access (CDMA), wideband CDMA (WCDMA), universal mobile telecommunications system), wireless broadband (UMTS), or global system for mobile communications (GSM), or the like, as cellular communication protocol. Furthermore, the wireless communication may include, for example, a local area network 164. The local area network 164 may include at least one of a Wi-Fi, a near field communication (NFC), or a global navigation satellite system (GNSS), or the like. The GNSS may include at least one of a GPS, a global navigation satellite system (GLONASS), Beidou navigation satellite system (hereinafter referred to as “Beidou”), the European global satellite-based navigation system (Galileo), or the like. In this specification, “GPS” and “GNSS” may be interchangeably used. The wired communication may include at least one of, for example, a universal serial bus (USB), a high definition multimedia interface (HDMI), a recommended standard-232 (RS-232), a plain old telephone service (POTS), or the like. The network 162 may include at least one of telecommunications networks, for example, a computer network (e.g., local area network (LAN) or wide area network (WAN)), an Internet, or a telephone network.

Each of the first and second external electronic devices 102 and 104 may be a device of which the type is different from or the same as that of the electronic device 101. According to an embodiment of the present disclosure, the server 106 may include a group of one or more servers. According to various embodiments of the present disclosure, all or a portion of operations that the electronic device 101 will perform may be executed by another or plural electronic devices (e.g., the external electronic devices 102 and 104 and the server 106). According to an embodiment of the present disclosure, in the case where the electronic device 101 executes any function or service automatically or in response to a request, the electronic device 101 may not perform the function or the service internally, but, alternatively additionally, it may request at least a part of a function associated with the electronic device 101 at other device (e.g., the external electronic device 102 or 104 or the server 106). The other electronic device (e.g., the external electronic device 102 or 104 or the server 106) may execute the requested function or additional function and may transmit the execution result to the electronic device 101. The electronic device 101 may provide the requested function or service using the received result or may additionally process the received result to provide the requested function or service. To this end, for example, cloud computing, distributed computing, or client-server computing may be used.

The image data processing module 180 may process image data. According to an embodiment of the present disclosure, the image data processing module 180 may analyze image data inputted as a reference image. For example, the image data processing module 180 may divide the reference image into a plurality of areas and may extract (or determine) a dominant color for each area. Furthermore, the image data processing module 180 may extract (or determine) a gradient direction.

According to various embodiments of the present disclosure, the image data processing module 180 may modify the extracted dominant color. Furthermore, the image data processing module 180 may apply a gradient effect to an image corresponding to a target area based on information obtained by analyzing the image data, the dominant color extracted for each area, and color obtained by modifying the dominant color. Alternatively, the image data processing module 180 may generate a dominant image of a designated size using the extracted dominant color or the modified dominant color. According to various embodiments of the present disclosure, the image data processing module 180 may output the generated dominant image on the target area without modification. Alternatively, the image data processing module 180 may modify the dominant image and may output the modified image on the target area. In this regard, the target area may be a designated area of a screen of the display 160 and may be an area on which a gradient image is outputted or to which a gradient effect is applied.

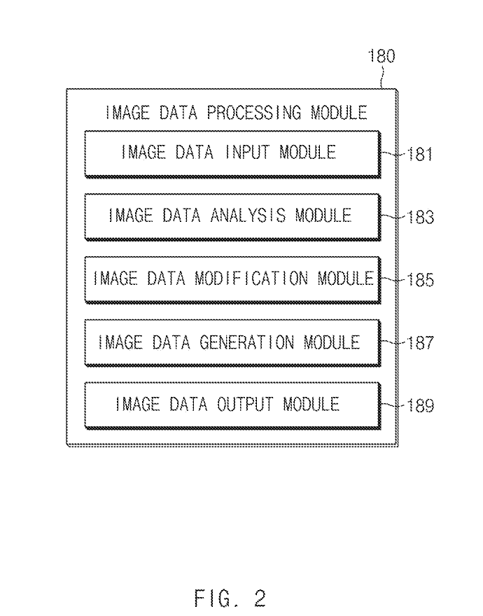

FIG. 2 is a view illustrating an image data processing module according to various embodiments of the present disclosure.

Referring to FIG. 2, the image data processing module 180 may include an image data input module 181, an image data analysis module 183, an image data modification module 185, an image data generation module 187, and an image data output module 189. The image data input module 181 may receive a reference image. According to an embodiment of the present disclosure, the image data input module 181 may collect image data from the memory 130 or may collect image data from an external electronic device (e.g., the first or second external electronic device 102 or 104, or the server 106) connected through the communication interface 170. The image data input module 181 may provide the collected image data to the image data analysis module 183.

In this regard, a reference image may be selected by a user or by setting information of a platform (or OS) or an application. For example, a user may designate an image selected through an image selection screen as the reference image. Alternatively, a theme image or a wall paper image may be designated as the reference image based on the setting information of the platform. According to an embodiment of the present disclosure, at least one of images that are included in an application may be designated as the reference image based on information set for each application. For example, in a music playback application, an album image of music, which is currently being played, may be designated as the reference image.

The image data analysis module 183 may divide the reference image into a plurality of areas. According to various embodiments of the present disclosure, the image data analysis module 183 may select a plurality of feature points on the reference image and may divide an area into a plurality of polygons in which the selected feature points are vertexes. According to an embodiment of the present disclosure, the image data analysis module 183 may divide the reference image into a plurality of areas by connecting a point located at a side of the reference image and to a point located at another side of the reference image.

According to various embodiments of the present disclosure, the image data analysis module 183 may extract (or determine) a dominant color about each of the divided areas. According to an embodiment of the present disclosure, the image data analysis module 183 may extract the dominant color through a method such as a color quantization method, a color normalization method, a cluster analysis method, or the like. Furthermore, the image data analysis module 183 may extract (or determine) a gradient direction.

The image data modification module 185 may modify the extracted dominant color. For example, in the case where the dominant colors extracted for respective areas are the same as or similar to each other or in the case where the dominant colors extracted for respective areas are the same as or similar to a color of an area adjacent to a target area, the image data modification module 185 may adjust saturation or brightness of the dominant color. The image data modification module 185 may resize an image. For example, the image data modification module 185 may resize a reference image, a gradient image, or an image, to which a gradient effect is applied, corresponding to the target area. Furthermore, the image data modification module 185 may modify an image. For example, the image data modification module 185 may modify the reference image, the gradient image, or the image corresponding to the target area by blurring or cropping the reference image, the gradient image, or the image corresponding to the target area.

The image data generation module 187 may generate a gradient image based on the extracted dominant color. For example, the image data generation module 187 may generate the gradient image in a radial gradient method, a mesh gradient method, a blur gradient method, or the like. According to various embodiments of the present disclosure, the image data generation module 187 may generate the gradient image using various gradient effect methods in addition to the above-described gradient methods or using a combination of two or more gradient methods.

The image data output module 189 may output the generated gradient image. For example, the image data output module 189 may output the generated gradient image on the display 160 such that the gradient image corresponds to the target area. In this case, the image data output module 189 may output the generated gradient image without modification or may modify and output the generated gradient image through the image data modification module 185. Furthermore, the image data output module 189 may apply a gradient effect to an image corresponding to the target area and may output the image to which the gradient effect is applied.

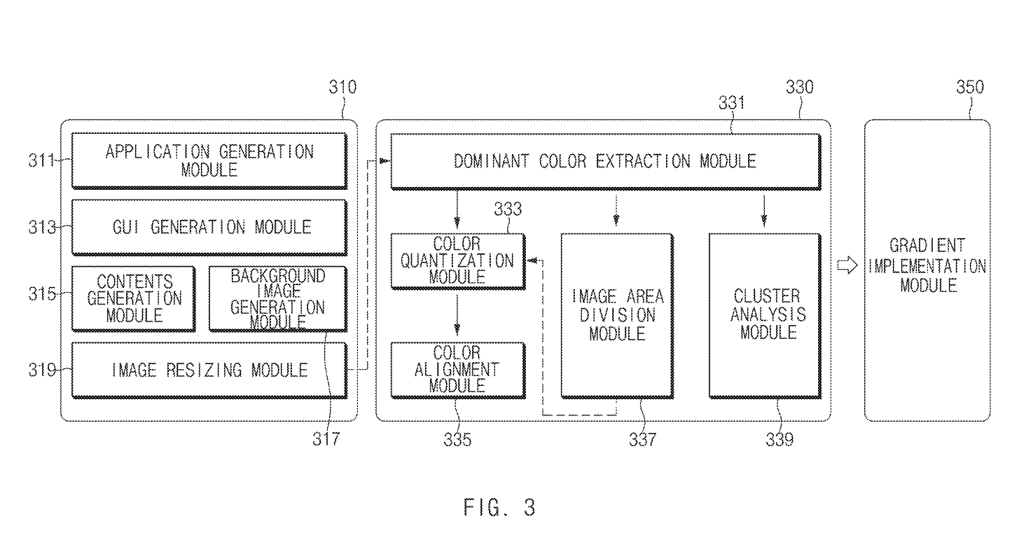

FIG. 3 is a view illustrating architecture of modules that are associated with image data processing and operate when executing a designated application according to various embodiments of the present disclosure.

Referring to FIG. 3, the electronic device 101 may include an application management module 310, a dominant color generation module 330, and a gradient implementation module 350. The application management module 310 may manage a life cycle (e.g., an execution/termination cycle) of an application included in the electronic device 101. The application management module 310 may include an application generation module 311, a graphic user interface (GUI) generation module 313, a contents generation module 315, a background image generation module 317, or an image resizing module 319. In addition, at least one element may be additionally included in the application management module 310, and at least one of the above-described elements may be omitted from the application management module 310.

According to various embodiments of the present disclosure, when executing a designated application, the application generation module 311 may generate a module, a program, a routine, sets of instructions, a process, or the like associated with the corresponding application or may load them on a memory. The GUI generation module 313 may generate a GUI associated with the corresponding application. For example, the GUI generation module 313 may prepare a basis for outputting various contents included in the corresponding application on a screen and may provide a user environment implemented with a graphic object such as a button, an icon, a menu, or the like.

According to various embodiments of the present disclosure, the contents generation module 315 may generate various contents included in the corresponding application. For example, the contents generation module 315 may generate a text, an image, an icon, a symbol, or the like included in the corresponding application through a GUI implemented to fit into a platform (or an OS). The background image generation module 317 may generate a background image of the corresponding application. For example, the background image generation module 317 may generate a background image based on an execution state or an execution sequence of the corresponding application. According to various embodiments of the present disclosure, the background image generation module 317 may designate a gradient image, which is generated based on contents, as a background image. According to an embodiment of the present disclosure, in the case where the contents are an album image of a sound source included in a music playback application, the background image generation module 317 may designate a gradient image, which is generated by using the album image as a reference image, as a background image. The image resizing module 319 may resize the reference image. Furthermore, the image resizing module 319 may resize the generated gradient image or an image, to which gradient effect is applied, corresponding to a target area.

According to various embodiments of the present disclosure, the dominant color generation module 330 may generate a dominant color based on the reference image. The dominant color generation module 330 may include a dominant color extraction module 331, a color quantization module 333, a color alignment module 335, an image area division module 337, a cluster analysis module 339, and the like. The dominant color extraction module 331 may extract a dominant color from the reference image. In this case, the dominant color extraction module 331 may use the reference image resized by the image resizing module 319. According to an embodiment of the present disclosure, the dominant color extraction module 331 may extract a dominant color based on at least one element included in the dominant color generation module 330. For example, the dominant color extraction module 331 may extract a dominant color by using a color quantization method based on the color quantization module 333. Furthermore, the dominant color extraction module 331 may extract a dominant color using a cluster analysis method based on the cluster analysis module 339. According to an embodiment of the present disclosure, the dominant color extraction module 331 may extract a dominant color by combining functions of corresponding modules based on two or more elements included in the dominant color generation module 330.

According to various embodiments of the present disclosure, the color quantization module 333 may use a tree structure. The color quantization module 333 may dynamically implement a tree while scanning a reference image. In the case where the number of leaves of the tree is less than a designated value (e.g., the number of colors to be used), the color quantization module 333 may constitute a palette with colors which are represented by respective leaves. According to various embodiments of the present disclosure, the color quantization module 333 may perform a corresponding function with respect to each of areas into which the reference image is divided by the image area division module 337. The color alignment module 335 may arrange, for example, colors used frequently in the corresponding area in a sequence.

According to various embodiments of the present disclosure, the image area division module 337 may divide a reference image into a plurality of areas. According to various embodiments of the present disclosure, the image area division module 337 may select a plurality of feature points on the reference image and may divide an area into a plurality of polygons in which the selected feature points are vertexes, respectively. According to an embodiment of the present disclosure, the image area division module 337 may divide the reference image into a plurality of areas by connecting a point located at each side of the reference image to a point located at another side of the reference image.

According to various embodiments of the present disclosure, the cluster analysis module 339 may group reference images in units of colors that are similar to or the same as each other. According to an embodiment of the present disclosure, the cluster analysis module 339 may use a K-means algorithm. For example, the cluster analysis module 339 may group data (e.g., color values) into k clusters. In this case, the cluster analysis module 339 may divide a reference image into k areas, and each cluster may be represented by a center point (e.g., centroid). Accordingly, the cluster analysis module 339 may extract a dominant color by applying a relatively higher weight value to color that is crowded in a small area compared to color that is distributed in a wide area. According to various embodiments of the present disclosure, at least one another element may be additionally included in the dominant color generation module 330, and at least one of the above-described elements may be omitted from the dominant color generation module 330.

According to various embodiments of the present disclosure, the gradient implementation module 350 may generate a gradient image based on a dominant color generated by the dominant color generation module 330 or may apply a gradient effect to an image corresponding to a target area. According to an embodiment of the present disclosure, the gradient implementation module 350 may operate according to a radial gradient method, a mesh gradient method, a blur gradient method, or the like.

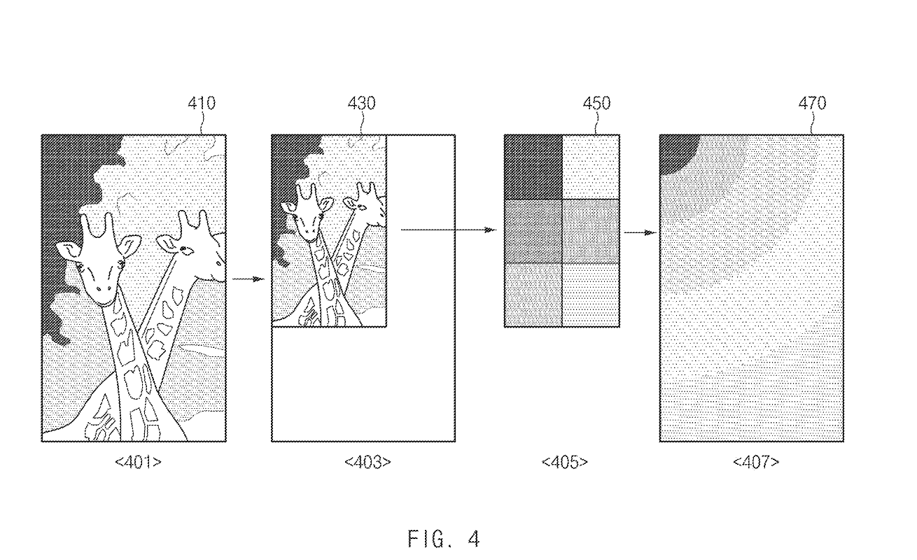

FIG. 4 is a view for describing a method for generating a gradient image using a reference image according to various embodiments of the present disclosure.

Referring to FIG. 4, according to various embodiments of the present disclosure, the electronic device 101 may resize a reference image 410 selected in state 401 into a reduced image 430 as shown in state 403. In state 403, the electronic device 101 may divide the reduced image 430 into a plurality of areas. FIG. 4 illustrates a screen in which the electronic device 101 divides the reduced image 430 into six areas. Furthermore, the electronic device 101 may extract dominant colors 450 for respective divided areas as shown in state 405. For example, the electronic device 101 may extract (or determine) the dominant colors 450 for respective divided areas by using a color quantization method, a color normalization method, a cluster analysis method, or the like. Furthermore, the electronic device 101 may extract (or determine) a gradient direction. As shown in state 407, the electronic device 101 may generate a gradient image 470 based on the extracted gradient direction and the dominant colors 450 extracted for respective areas.

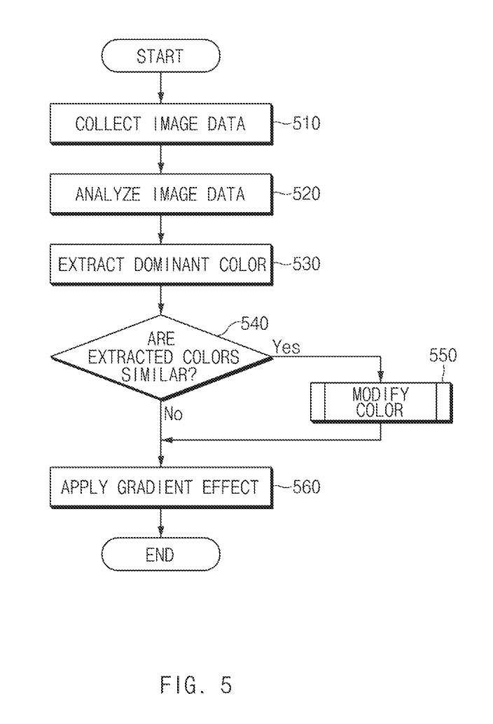

FIG. 5 is a flowchart illustrating an operation method of an electronic device associated with a method for generating a gradient image using a reference image according to various embodiments of the present disclosure.

Referring to FIG. 5, according to various embodiments of the present disclosure, the electronic device 101 may collect image data in operation 510. For example, the electronic device 101 may collect image data from the memory 130 or from an external electronic device connected through the communication interface 170. The collected image data may be designated as a reference image by a user selection or by setting information of a platform (or OS) or an application. According to various embodiments of the present disclosure, the electronic device 101 may resize the reference image before performing operation 520.

According to various embodiments of the present disclosure, in operation 520, the electronic device 101 may analyze the collected image data. According to an embodiment of the present disclosure, the electronic device 101 may divide image data into a plurality of areas. For example, the electronic device 101 may select a plurality of feature points by analyzing the image data and may divide an area into a plurality of polygons in which the feature points are vertexes. Furthermore, the electronic device 101 may extract a gradient direction by analyzing the image data.

According to various embodiments of the present disclosure, in operation 530, the electronic device 101 may extract a dominant color for each divided area. According to an embodiment of the present disclosure, the electronic device 101 may extract a dominant color by using a color quantization method, a color normalization method, a cluster analysis method, or the like.

According to various embodiments of the present disclosure, in operation 540, the electronic device 101 may determine whether the dominant colors extracted for respective areas are the same as or similar to each other. According to an embodiment of the present disclosure, the electronic device 101 may determine whether the dominant color extracted for each area is the same as or similar to a color of an area adjacent to a target area.

According to various embodiments of the present disclosure, in the case where the extracted dominant colors are similar to each other, the electronic device 101 may modify at least one dominant color among the dominant colors in operation 550. For example, the electronic device may adjust saturation or brightness of the at least one dominant color. In operation 560, the electronic device 101 may generate a gradient image using the dominant colors extracted for respective areas or the at least one modified dominant color together with the extracted gradient direction or may apply a gradient effect to an image corresponding to the target area.

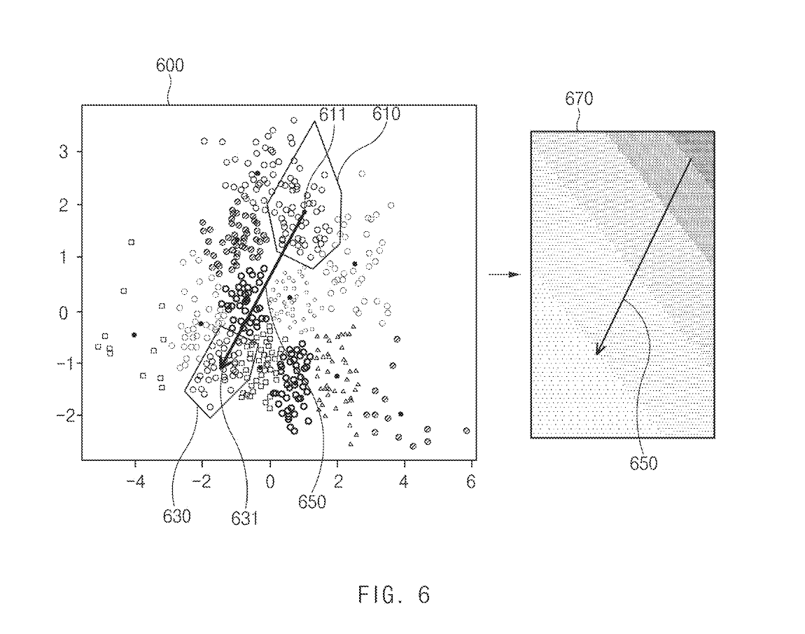

FIG. 6 is a view for describing a method for extracting a gradient direction according to various embodiments of the present disclosure.

Referring to FIG. 6, according to various embodiments of the present disclosure, as shown in a screen 600, the electronic device 101 may analyze a reference image and may group similar colors as a cluster for classification based on the analysis result. Furthermore, the electronic device 101 may select a first cluster 610 and a second cluster 630 in the order of high clustering degrees. In this case, a center point of each cluster may represent each cluster. For example, the first cluster 610 may be represented with a first center point 611, and the second cluster 630 may be represented with a second center point 631. In this regard, a center point of each cluster may be designated with a centroid of each cluster. For example, the electronic device 101 may designate a centroid, which is calculated using an average value of coordinates (e.g., x-coordinates and y-coordinates) of all pixels included in each cluster, as a center point of each cluster. According to various embodiments of the present disclosure, the electronic device 101 may designate a direction of a line heading to the second center point 631 from the first center point 611 as a gradient direction 650. Accordingly, the electronic device may generate a gradient image 670 in which a gradient is performed in the extracted gradient direction 650 based on corresponding colors.

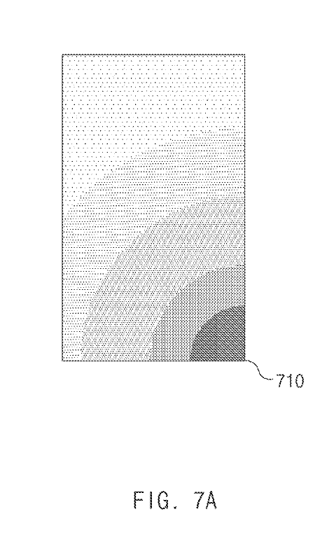

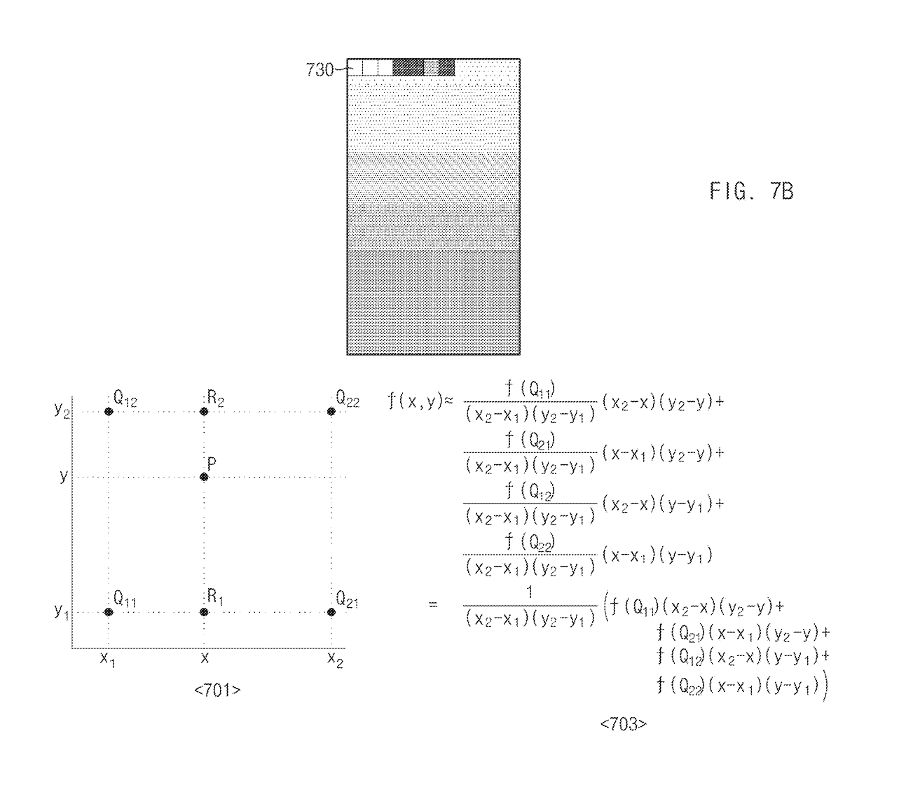

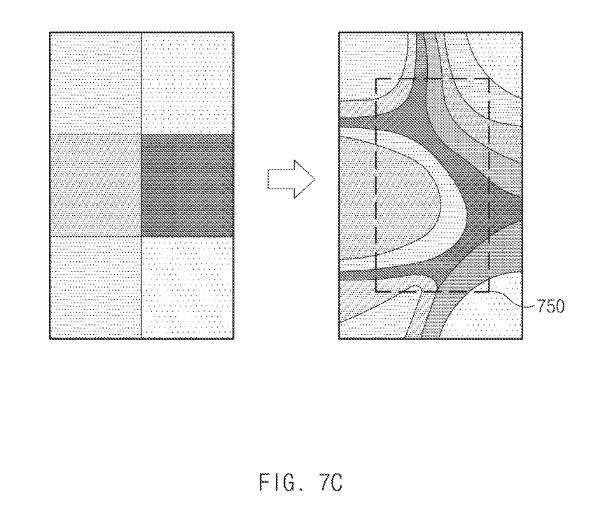

FIG. 7A is a view for describing a radial gradient effect of gradient effects according to various embodiments of the present disclosure.

Referring to FIG. 7A, according to various embodiments of the present disclosure, the electronic device 101 may generate a gradient image to which a radial gradient effect is applied based on the extracted gradient direction and the extracted dominant color. As shown in FIG. 7A, the electronic device 101 may generate an image such that colors are distributed in areas defined by a plurality of circles each of which has a designated point 710 as a center point. According to various embodiments of the present disclosure, when extracting a gradient direction, the electronic device 101 may designate a center point (e.g., the first center point 611) of a cluster (e.g., the first cluster 610), which has the highest clustering degree, as the designated point 710.

FIG. 7B is a view for describing a mesh gradient effect of gradient effects according to various embodiments of the present disclosure.

Referring to FIG. 7B, according to various embodiments of the present disclosure, the electronic device 101 may divide a reference image into a plurality of areas 730 and may extract a dominant color for each divided area of the plurality of areas 730. Furthermore, the electronic device 101 may generate a gradient image to which the mesh gradient effect is applied based on the dominant color of each divided area of the plurality of areas 730.

According to various embodiments of the present disclosure, the electronic device 101 may calculate a color of a calculating point by interpolating vertexes of each divided area of the plurality of areas 730. For example, if the vertexes of each divided area of the plurality of areas 730 are assumed as Q₁₁ to Q₂₂ as shown in graph 701 of FIG. 7B, a color of a calculating point P may be calculated by equation 703 of FIG. 7B. As such, the electronic device 101 may calculate a color at each point in each area of the plurality of areas 730 such that weight values for colors are different from each other based on a distance between the point P and each vertex. Even though coordinates and an equation corresponding to the case that the number of vertexes is four are illustrated in FIG. 7B, the electronic device 101 may be applicable to the case that the number of vertexes is more than four, by using an equation that is more complex than the equation 703 of FIG. 7B.

FIG. 7C is a view for describing a blur gradient effect of gradient effects according to various embodiments of the present disclosure.

Referring to FIG. 7C, according to various embodiments of the present disclosure, the electronic device 101 may divide a reference image into a plurality of areas and may extract a dominant color for each divided area. Furthermore, the electronic device 101 may fill each area with the corresponding dominant color. According to an embodiment of the present disclosure, the electronic device 101 may draw a quadrangle for each area using the dominant color. Furthermore, the electronic device 101 may apply a blur effect (e.g., Gaussian blur or the like) to at least a partial area. Accordingly, the electronic device 101 may generate an image, to which a gradient effect is applied, in a designated area 750.

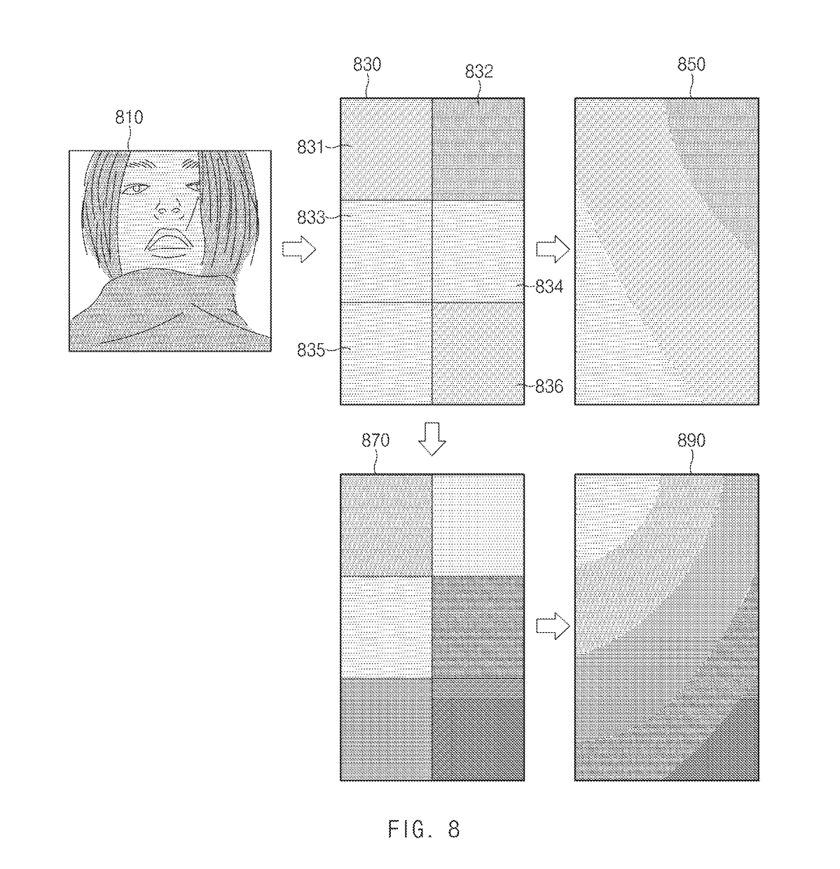

FIG. 8 illustrates a view for describing color modification according to various embodiments of the present disclosure.

Referring to FIG. 8, according to various embodiments of the present disclosure, the electronic device 101 may resize a reference image 810, divide the resized image into a plurality of areas, and extract a dominant color for each area. As illustrated in FIG. 8, an embodiment shows a screen in which the electronic device 101 divides the resized image into six areas and extracts a dominant color for each area. Furthermore, the electronic device 101 may generate an image 830 in which the divided areas are respectively filled with the dominant colors extracted for respective divided areas.

According to various embodiments of the present disclosure, in the case where the extracted dominant colors are the same as or similar to each other or in the case where the dominant color extracted for each area is the same as or similar to a color of an area adjacent to a target area, the electronic device 101 may modify the dominant color. With regard to the color modification, the electronic device 101 may change a color model of the dominant color. For example, the electronic device 101 may change a corresponding color value from a red, green, and blue (RGB) color model to a hue, saturation, and value (HSV) color model. According to an embodiment of the present disclosure, when changing a color model, the electronic device 101 may not change a saturation value of the corresponding color in the case where the saturation value is less than a designated rate (e.g., 2%).

According to various embodiments of the present disclosure, the electronic device 101 may divide an image area with regard to the color modification. According to an embodiment of the present disclosure, the electronic device 101 may divide the image area for each dominant color. As illustrated in FIG. 8, an embodiment shows a screen in which the electronic device 101 divides the image 830 into areas each of which has the same dominant color. For example, the electronic device 101 may divide the image 830 into first to sixth areas 831 to 836. According to another embodiment of the present disclosure, the electronic device 101 may divide the image 830 into two areas. For example, the electronic device 101 may divide the image 830 into two areas: one including the first to third areas 831 to 833 and the other including the fourth to sixth areas 834 to 836.

According to various embodiments of the present disclosure, the electronic device 101 may adjust saturation or brightness of image data corresponding to a designated area (e.g., an area including the first to third areas 831 to 833). According to an embodiment of the present disclosure, the electronic device 101 may adjust brightness by raising the brightness as much as a designated value (e.g., 20) such that the brightness of the dominant colors filled in the designated area does not exceed a limit value (e.g., 100). Furthermore, the electronic device 101 may adjust saturation or brightness of image data corresponding to an area (e.g., an area including the fourth to sixth areas 834 to 836) in contrast to the designated area. According to an embodiment of the present disclosure, the electronic device 101 may raise a saturation value of the dominant colors filled in the opposed area and may raise or lower a brightness value. For example, the electronic device 101 may raise a saturation value by a designated value (e.g., 40) and raise a brightness value by a designated value (e.g., 10). Alternatively, in the case where a saturation value is less than a designated rate (e.g., 1%), the electronic device 101 may maintain the saturation value and lower the brightness value by a designated value (e.g., 20).

According to an embodiment of the present disclosure, the electronic device 101 may adjust at least one of saturation and brightness of image data corresponding to the designated area and adjust at least one of saturation and brightness of image data corresponding to the opposed area. According to another embodiment of the present disclosure, the electronic device 101 may adjust at least one of saturation and brightness of image data corresponding to the designated area or adjust at least one of saturation and brightness of image data corresponding to the opposed area.

According to various embodiments of the present disclosure, the electronic device 101 may obtain a modified image 870 through the above-described color modification. Furthermore, the electronic device 101 may generate a gradient image 890 based on the modified image 870 that has relatively high visibility about color compared to a gradient image 850 generated based on the image 830 that is the image before modification.

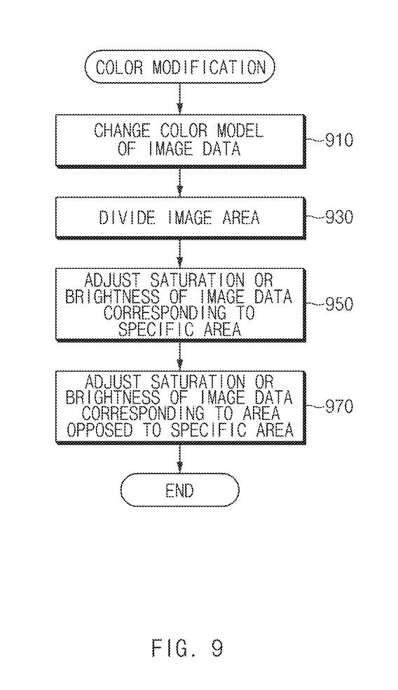

FIG. 9 is a flowchart illustrating an operation method of an electronic device associated with color modification according to various embodiments of the present disclosure.

Referring to FIG. 9, according to various embodiments of the present disclosure, in operation 910, the electronic device 101 may change a color model of image data. According to an embodiment of the present disclosure, the electronic device 101 may change a corresponding color value from the RGB color model to the HSV color model.

According to various embodiments of the present disclosure, in operation 930, the electronic device 101 may divide an image area. According to an embodiment of the present disclosure, the electronic device 101 may divide the image area in units of colors that are the same as each other. Alternatively, the electronic device 101 may divide the image into two areas based on a position (e.g., coordinate information) on a screen. For example, the electronic device 101 may divide an image into two areas: one area located on the upper-left and the other area located on the lower-right.

According to various embodiments of the present disclosure, in operation 950, the electronic device 101 may adjust saturation or brightness of image data corresponding to a designated area. According to an embodiment of the present disclosure, the electronic device 101 may change saturation or brightness of image data corresponding to the area located at the upper-left.

According to various embodiments of the present disclosure, in operation 970, the electronic device 101 may adjust saturation and brightness of image data corresponding to an area in contrast to the designated area. According to an embodiment of the present disclosure, the electronic device 101 may change saturation or brightness of image data corresponding to the area located at the lower-right.

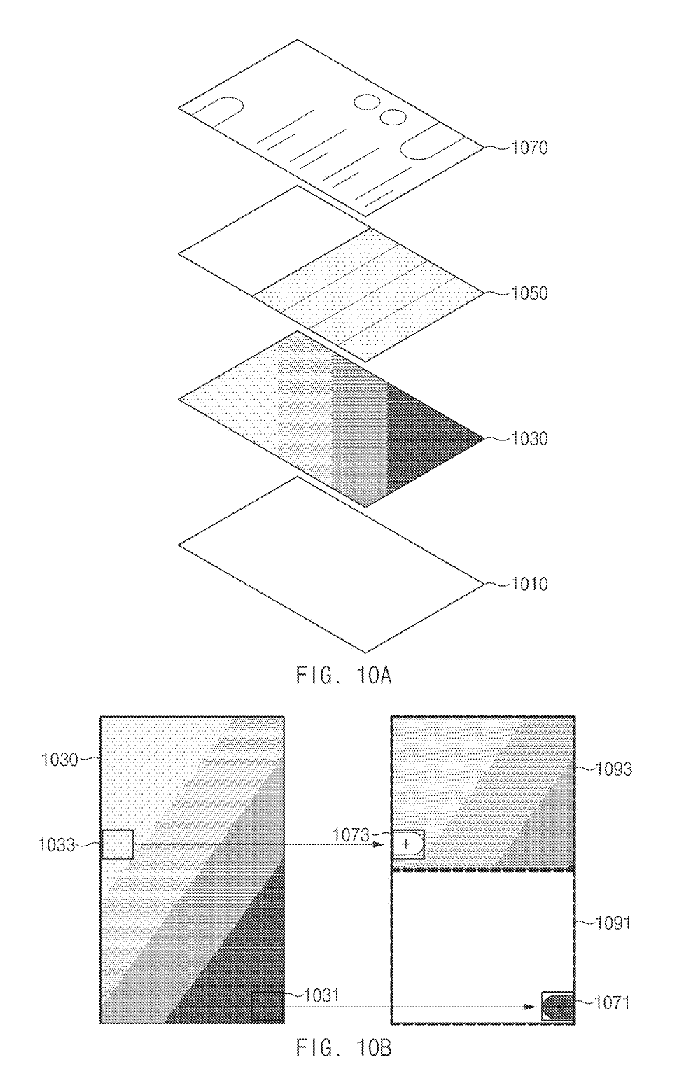

FIG. 10A is a separated perspective view of layers for describing a method for applying a gradient image for each layer according to various embodiments of the present disclosure, and FIG. 10B is a view illustrating the layers of FIG. 10A combined according to various embodiments of the present disclosure.

Referring to FIGS. 10A and 10B, according to various embodiments of the present disclosure, the electronic device 101 may output a designated screen (e.g., a home screen) on the display 160. As illustrated in FIG. 10A, the designated screen may be implemented with at least one layer (or a view). For example, a first layer 1030, a second layer 1050, and a third layer 1070 may constitute the designated screen. A background image may be implemented on the first layer 1030. In this case, the electronic device 101 may designate a gradient image, which is generated based on a reference image 1010, as a background image. The second layer 1050 may be outputted on the first layer 1030 and may be used as a contents area on which a system setting menu (e.g., a top-down menu, a bottom-up menu, or the like) or a pop-up object is outputted. Furthermore, the third layer 1070 may be outputted on the first layer 1030 or the second layer 1050 and may include various screen elements (or display objects).

According to various embodiments of the present disclosure, in the case where the designated screen is outputted on the display 160, the electronic device 101 may output the designated screen in which a gradient image is applied for each layer (or view). According to an embodiment of the present disclosure, the electronic device 101 may divide the reference image 1010 into a plurality of areas and extract a dominant color for each area. Furthermore, the electronic device 101 may designate a gradient image, which is generated using the dominant color, as a background image. In this case, when processing visualization about at least one screen element outputted on the second layer 1050 when outputting the designated screen, the electronic device 101 may display the corresponding area such that the background image implemented on the first layer 1030 is overlaid thereon. As illustrated in FIG. 10B, when outputting a first screen element 1071 implemented on the third layer 1070 on a contents area 1091 implemented on the second layer 1050, the electronic device 101 may output image data outputted on a designated area 1031 of the background image implemented on the first layer 1030 as the first screen element 1071, or the electronic device 101 may perform processing (e.g., blur processing, crop processing, transparency processing, or the like) with respect to the image data and output the processed data together with the first screen element 1071. In this regard, the designated area 1031 of the background image may be an area corresponding to an area on which the first screen element 1071 is outputted.

According to various embodiments of the present disclosure, when processing visualization about at least one screen element outputted on the first layer 1030 when outputting the designated screen, the electronic device 101 may output the background image without modification if a result of analyzing the screen element and colors of the background image indicates that a HSB value greater than a designated numerical value is secured. Otherwise, the electronic device 101 may output the background image after post-processing (e.g., color combination, complementary color, tone-down, or the like). For example, when outputting a second screen element 1073 implemented on the third layer 1070 on an exposed area 1093 of the first layer 1030, the electronic device 101 may analyze colors of the second screen element 1073 and image data outputted on a designated area 1033 of the background image. In this case, the electronic device 101 may output image data outputted on the designated area 1033 of the background image without modification if the analysis result indicates that the HSB value greater than a designated value is secured. Otherwise, the electronic device 101 may change the image data and output the changed image data. In this regard, the designated area 1033 of the background image may be an area corresponding to an area on which the second screen element 1073 is outputted.

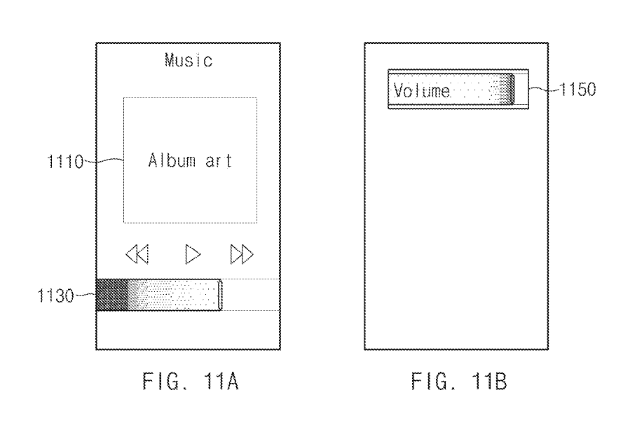

FIG. 11A is a view for describing a method for applying a gradient effect to a designated screen element according to various embodiments of the present disclosure, and FIG. 11B is a view for describing a method for applying a gradient effect to a designated another screen element according to various embodiments of the present disclosure.

Referring to FIGS. 11A and 11B, according to various embodiments of the present disclosure, when processing visualization about at least one screen element outputted on the display 160, the electronic device 101 may utilize a gradient image generated based on a reference image. In this regard, the screen element may be a designated form of display object that represents various contents (e.g., a text, an image, a video, an icon, a symbol, or the like) constituting a designated screen (e.g., a home screen). As illustrated in FIG. 11A, the electronic device 101 may output a gradient image, that is, a playback progress display object 1130, which is in the form of a progress bar, of screen elements that constitute an execution screen of a designated application (e.g., a music playback application). In this case, the electronic device 101 may determine at least one image 1110 (e.g., an album image of a sound source that is currently being played or the like) that constitutes the execution screen as a reference image. Furthermore, as illustrated in FIG. 11B, the electronic device 101 may output a display object 1150 for adjusting a volume level in the form of a slide bar as a gradient image.

According to various embodiments of the present disclosure, the electronic device 101 may determine the at least one image 1110 constituting the execution screen as a reference image, an image selected by a user through an image selection screen as the reference image, or a theme image or a wall paper image based on setting information of a platform as the reference image.

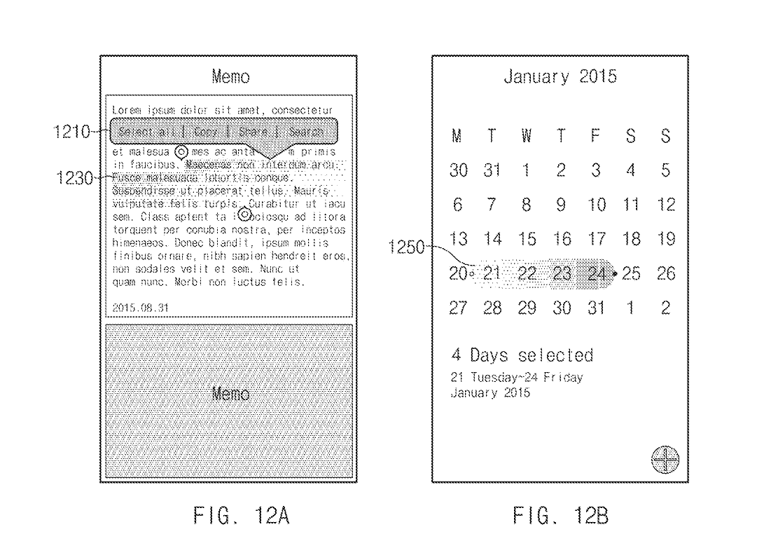

FIG. 12A is a view for describing a method for applying a gradient effect to a partial area of a screen according to various embodiments of the present disclosure, and FIG. 12B is a view for describing another method for applying a gradient effect to a partial area of the screen according to various embodiments of the present disclosure.

Referring to FIGS. 12A and 12B, according to various embodiments of the present disclosure, the electronic device 101 may output a partial area of a screen of the display 160 by utilizing a gradient image generated based on a reference image. As illustrated in FIG. 12A, in the case where an area 1230 of a text is selected, the electronic device 101 may output a result of applying the gradient effect to the area 1230. In this case, the electronic device 101 may designate a user defined image, a theme image, a wall paper image, or the like as a reference image.

According to various embodiments of the present disclosure, in the case where the area 1230 of the text is selected, the electronic device 101 may determine a background image of an outputted pop-up object 1210 (e.g., contextual pop-up) as a reference image. Alternatively, the electronic device 101 may output a background image of the outputted pop-up object 1210 by utilizing a gradient image.

As illustrated in FIG. 12B, according to various embodiments of the present disclosure, in the case where a user sets a schedule by selecting at least one date on a schedule management screen, to display the schedule, the electronic device 101 may apply and output a gradient effect to an area 1250, on which the at least one date corresponding to the schedule is displayed. In this case, the electronic device 101 may designate a user-designated image, a theme image, a wall paper image, or the like as a reference image.

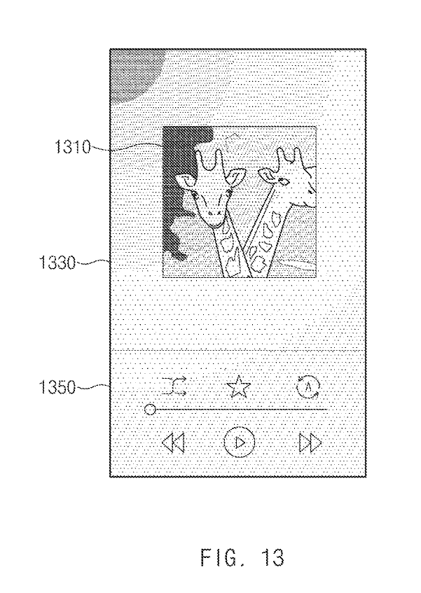

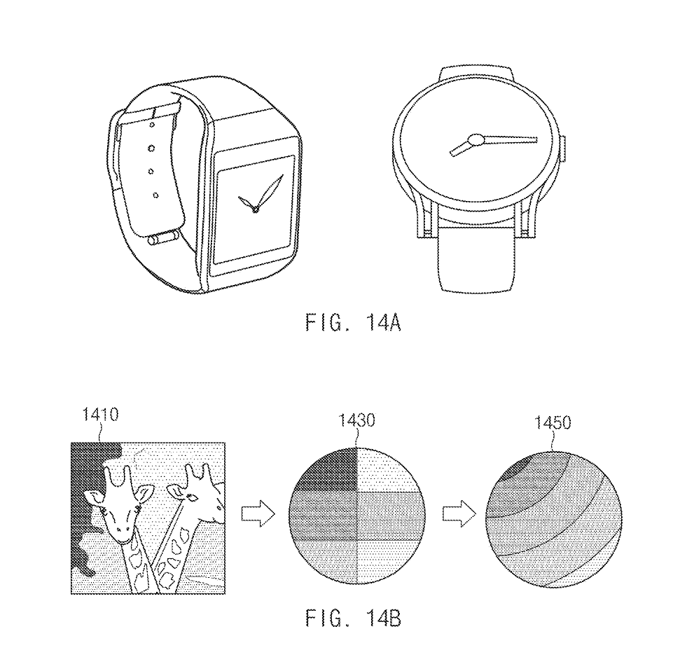

FIG. 13 is a view for describing a gradient effect applied when executing a designated application according to various embodiments of the present disclosure.

Referring to FIG. 13, according to various embodiments of the present disclosure, when executing a designated application, the electronic device 101 may output at least one screen element of the application, a background image, or the like by utilizing a gradient image. As illustrated in FIG. 13, when executing a music playback application, the electronic device 101 may output a background image 1330, a playback control display object 1350, or the like by utilizing a gradient image. In this case, the electronic device 101 may determine an album image 1310 of a sound source, which is currently being played, as a reference image.

FIG. 14A is a view for describing a size or shape of a target area according to various embodiments of the present disclosure, and FIG. 14B is a view for describing a method for modifying a gradient image based on the size or shape of the target area and for applying the modified gradient image according to various embodiments of the present disclosure.

Referring to FIG. 14A, according to various embodiments of the present disclosure, the display 160 of the electronic device 101 may be diverse in a size or shape. For example, in the case of a wearable device, a size of the display 160 may be limited, and a shape of the display may be implemented in various ways. According to various embodiments of the present disclosure, a size or shape of a screen element to which a gradient effect is to be applied may be implemented in various ways. For example, even though the electronic device 101 generates a gradient image of the same size based on the same reference image, a size or shape of the gradient image may vary according to the size or shape of the screen element. In this case, the electronic device 101 may modify and use the gradient image based on the size or shape of the target area.

As illustrated in FIG. 14B, according to various embodiments of the present disclosure, when generating a gradient image 1450 based on a reference image 1410, the electronic device 101 may perform modification processing. For example, the electronic device 101 may perform modification processing (e.g., crop processing or the like) to be suitable for a size and shape of a target area 1430 when dividing the reference image 1410 into a plurality of areas and generating an image using a dominant color that is extracted for each area. Furthermore, the electronic device 101 may generate the gradient image 1450 by applying a gradient effect to the modified image.

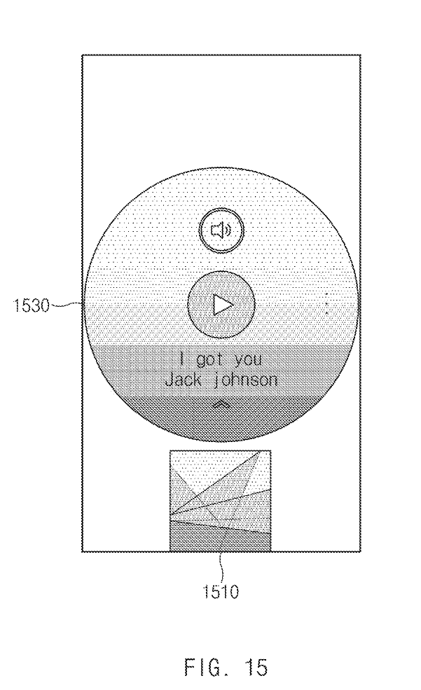

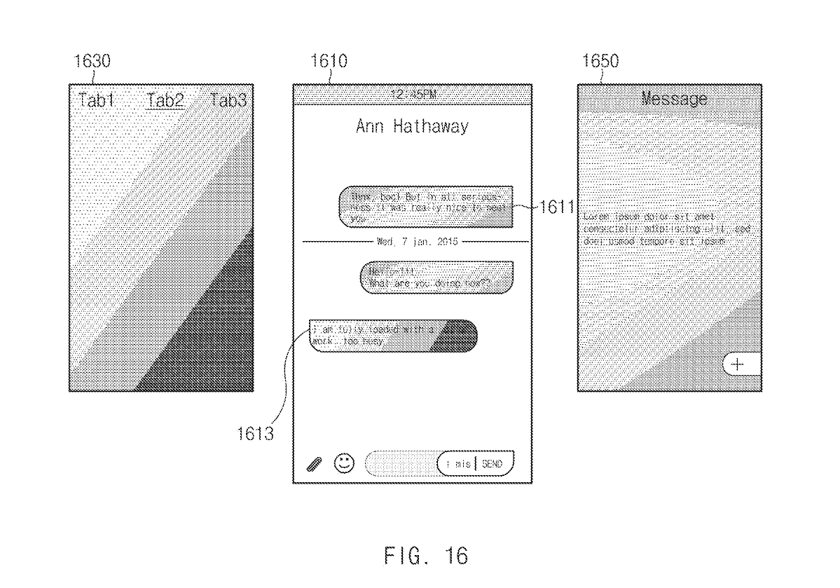

FIG. 15 is a view of a screen on which a gradient image is modified according to a size or shape of a target area when executing a designated application according to various embodiments of the present disclosure.

Referring to FIG. 15, according to various embodiments of the present disclosure, the electronic device 101 may designate an album image of a sound source, which is currently being reproduced, as a reference image when executing a music playback application. The electronic device 101 may resize a reference image 1510, divide the resized reference image into a plurality of areas, and extract a dominant color for each area. Furthermore, the electronic device 101 may extract a gradient direction and generate a gradient image in the extracted gradient direction based on a dominant color extracted for each area.

As illustrated in FIG. 15, according to various embodiments of the present disclosure, the electronic device 101 may set a target area 1530 of a record shape according to the music playback application. In this case, the electronic device 101 may modify the generated gradient image so as to correspond to the size and shape of the target area 1530 and may output the modified gradient image.

FIG. 16 is a view for describing a method for utilizing a gradient image specified for each user according to various embodiments of the present disclosure.

Referring to FIG. 16, according to various embodiments of the present disclosure, the electronic device 101 may utilize a gradient image designated for each user. For example, when outputting a screen (e.g., a message transmission/reception screen, or the like) associated with a plurality of users like a messenger application or the like, the electronic device 101 may utilize the gradient image designated for each user.

As illustrated in FIG. 16, according to various embodiments of the present disclosure, when outputting a message transmission/reception screen 1610, the electronic device 101 may utilize a gradient image 1650 designated to a terminal of a first user for a text box 1611 on which a message sent by the first user is displayed and may utilize a gradient image 1630 designated to a terminal of a second user for a text box 1613 on which a message sent by the second user is displayed. In this case, the electronic device 101 may receive a gradient image designated for each user from a terminal of each user or may receive information (e.g., a gradient direction, a dominant color, or the like) associated with the gradient image.

According to various embodiments of the present disclosure, when outputting the message transmission/reception screen 1610, the electronic device 101 may generate a gradient image corresponding to each user by utilizing information of each user stored in the electronic device 101. According to an embodiment of the present disclosure, the electronic device 101 may utilize the stored conversation counterpart list (e.g., buddy list) associated with a messenger application. For example, the electronic device 101 may generate a gradient image by designating a representative image (e.g., a profile image) of a conversation counterpart as a reference image.

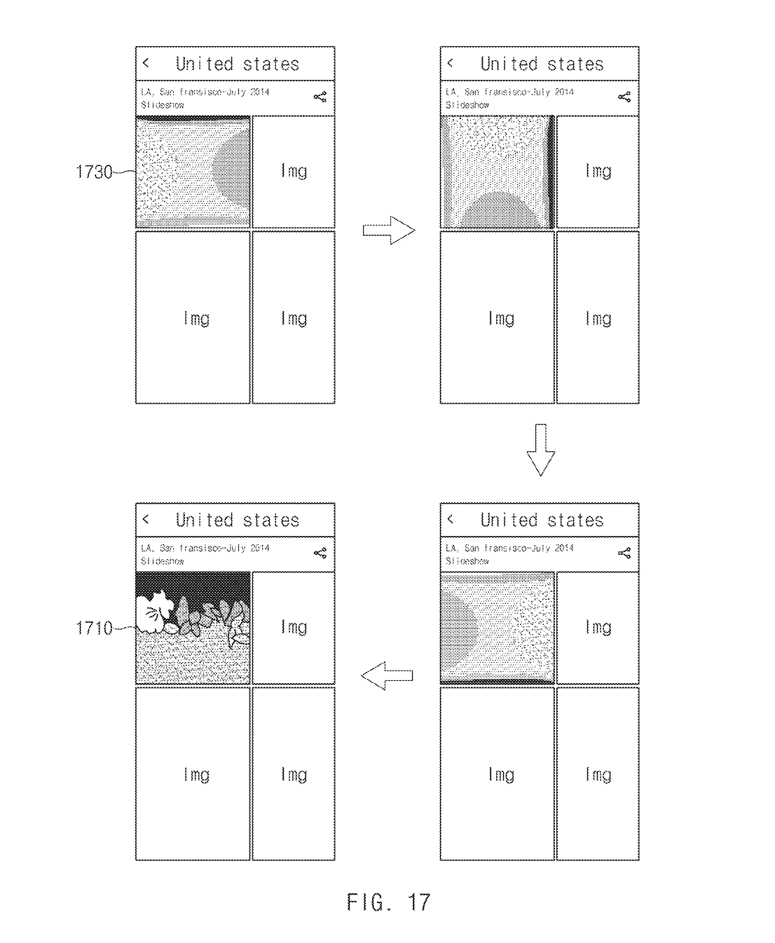

FIG. 17 is a view for describing a method for utilizing a gradient image when loading a reference image according to various embodiments of the present disclosure.

Referring to FIG. 17, according to various embodiments of the present disclosure, in the case where a loading time takes long in outputting an image, the electronic device 101 may store a corresponding image as a reference image and may utilize a gradient image generated based on the reference image. As illustrated in FIG. 17, when executing an image list management application (e.g., a photo album or the like), it may take a long time for the electronic device 101 to load an image 1710. In this case, the electronic device 101 may store the image 1710 as a reference image and first output a gradient image 1730 generated based on the reference image on a location on which the image 1710 is to be outputted. Furthermore, to dynamically display a loading progress status, the electronic device 101 may output the gradient image 1730 by applying an animation effect to the gradient image 1730. For example, the electronic device 101 may output the gradient image 1730 by rotating the gradient image 1730 by a designated time interval, by changing the transparency of the gradient image 1730, or by changing a location of a color of the gradient image 1730.

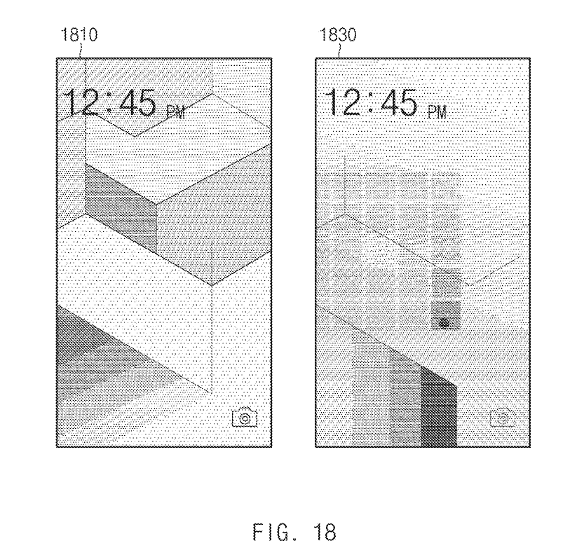

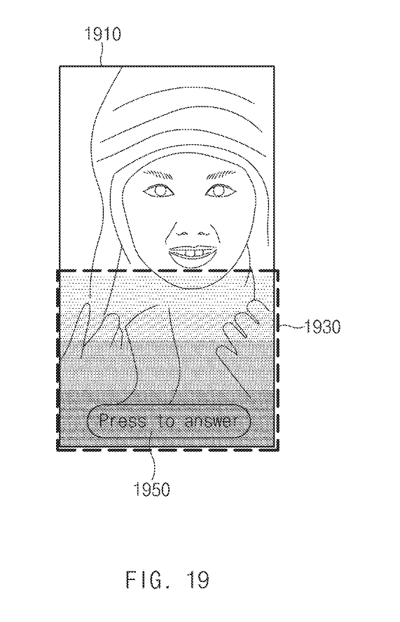

FIG. 18 is a view for describing a method for utilizing a gradient image when switching a designated screen according to various embodiments of the present disclosure.

Referring to FIG. 18, according to various embodiments of the present disclosure, the electronic device 101 may utilize a gradient image for smooth screen switching when switching a designated screen. As illustrated in FIG. 18, when switching from a first screen (e.g., a lock screen) to a second screen (e.g., a home screen), the electronic device 101 may designate a background image 1810 of the first screen as a reference image and may utilize a gradient image 1830 generated based on the reference image. For example, the electronic device 101 may designate a background image of a lock screen as a reference image and may generate a gradient image based on the reference image. In this case, when outputting a home screen in response to an unlock input, the electronic device 101 may apply the generated gradient image in the middle of screen transition. According to an embodiment of the present disclosure, the electronic device 101 may designate a background image of the second screen as a reference image, generate a gradient image based on the reference image, and apply the generated gradient image in the middle of transition.

FIG. 19 is a view for describing a method for utilizing a gradient image in response to a designated state of an electronic device according to various embodiments of the present disclosure.

Referring to FIG. 19, according to various embodiments of the present disclosure, the electronic device 101 may utilize a gradient image in response to a designated state. For example, the electronic device 101 may utilize the gradient image when it is necessary to notify a user of occurrence of a designated event, such as an incoming call state, an alarm notification state, a message reception notification state, or the like. As illustrated in FIG. 19, when outputting a screen in response to the incoming call state, the electronic device 101 may output a profile image 1910 of the counterpart as a background image. In this case, the electronic device 101 may designate the profile image 1910 of the counterpart as the reference image and generate a gradient image 1930 based on the reference image. Furthermore, the electronic device 101 may output the generated gradient image 1930 on the background image. According to an embodiment of the present disclosure, the electronic device may prevent the profile image 1910 or a designated screen element 1950 (e.g., an incoming call button, or the like) from being covered by transparently outputting the gradient image 1930. According to an embodiment of the present disclosure, the electronic device 101 may output the gradient image 1930 to which an animation effect is applied. As such, the electronic device 101 may represent that an incoming call state is in progress.

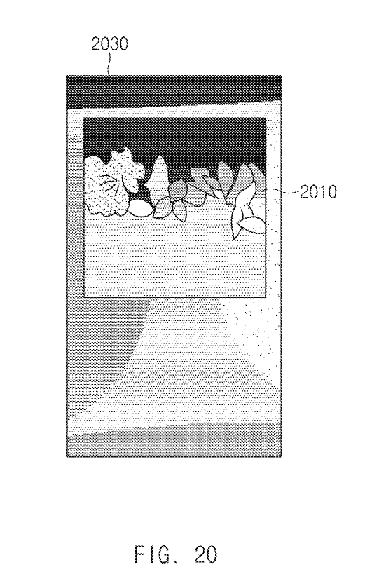

FIG. 20 is a view for describing a method for utilizing a gradient image when outputting contents transmitted/received in real time on a screen according to various embodiments of the present disclosure.

Referring to FIG. 20, according to various embodiments of the present disclosure, the electronic device 101 may utilize a gradient image when outputting contents transmitted/received in real time on a screen. For example, when receiving contents from an external electronic device through the communication interface 170, the electronic device 101 may designate an image associated with the contents as a reference image and may utilize a gradient image generated based on the reference image. As illustrated in FIG. 20, the electronic device 101 may designate a feed image 2010 received in real time as a reference image and may output a gradient image 2030 generated based on the reference image as a background image of the feed image 2010.

According to various embodiments of the present disclosure, an electronic device is provided. The electronic device includes a display, a processor electrically connected with the display, and a memory electrically connected with the processor. The memory includes instructions, the instructions, when executed by the processor, instructing the processor to change a first image such that the first image including a first amount of data is changed to comprise a second amount of data that is less than the first amount of data, extract at least one dominant color of at least one partial area of the changed first image, perform a gradient in the at least one partial area of the changed first image based on the extracted at least one dominant color, and display a second image including the at least one partial area to which the gradient is applied on at least one part of the display.

According to various embodiments of the present disclosure, the instructions may further instruct the processor to change the first image by performing at least one of a resolution reduction, interpolation, and sampling with respect to at least one part of the first image.

According to various embodiments of the present disclosure, the instructions may further instruct the processor to extract at least one color which is the most used color included in the at least one partial area of the changed first image as the at least one dominant color.

According to various embodiments of the present disclosure, the instructions may further instruct the processor to extract at least one color which is the most used color included in at least one edge of the at least one partial area of the changed first image as the at least one dominant color.

According to various embodiments of the present disclosure, the instructions may further instruct the processor to change at least one of a saturation and a brightness of at least one first dominant color of a first area of the changed first image or at least one second dominant color of a second area of the changed first image when a difference in hue between the at least one first dominant color and the at least one second dominant color is within a designated range and to perform a gradient based on at least one of the change at least one first dominant color and the changed at least one second dominant color.

According to various embodiments of the present disclosure, the instructions may further instruct the processor to output image data corresponding to at least one partial area of the second image as at least one part of a display object to be displayed on the at least one partial area of the second image when outputting the display object.

According to various embodiments of the present disclosure, the instructions may further instruct the processor to analyze first image data corresponding to at least one partial area of the second image and second image data of a display object when outputting the display object to be displayed on the at least one partial area of the second image, to change at least one of the first image data and the second image data when difference values between color parameters of the first image data and color parameters of the second image data are within a designated range, and to output at least one of the changed first image data and the changed second image data as at least one part of the display object, wherein the color parameters include hue, saturation, and brightness.

According to various embodiments of the present disclosure, the instructions may further instruct the processor to modify the second image based on at least one of a size and a shape of the at least one part of the display and to display the modified second image on the at least one part of the display.

According to various embodiments of the present disclosure, the instructions may further instruct the processor to designate an image selected by one of a user and setting information of a platform or an application as the first image.

According to various embodiments of the present disclosure, the instructions may further instruct the processor to display the second image on an area when outputting a display object which is touchable and represents information on the area.

According to various embodiments of the present disclosure, an electronic device is provided. The electronic device includes a display, a processor electrically connected with the display, and a memory electrically connected with the processor. The memory includes instructions, the instructions, when executed by the processor, instructing the processor to generate a second image that includes a first image stored in the memory and a peripheral area that encompasses at least a part of the first image, perform a first gradient in a third area of the peripheral area adjacent to a first area of the first image based on a first dominant color of the first area, perform a second gradient in a fourth area of the peripheral area adjacent to a second area of the first image based on a second dominant color of the second area, and display the second image, in which the first gradient and the second gradient are performed, on at least a part of the display.

According to various embodiments of the present disclosure, a method for processing image data is provided. The method includes changing a first image such that the first image including a first amount of data is changed to comprise a second amount of data that is less than the first amount of data, extracting at least one dominant color of at least one partial area of the changed first image, performing a gradient in the at least one partial area of the changed first image based on the extracted at least one dominant color, and displaying a second image including the at least one partial area to which the gradient is applied on at least one part of the display.

According to various embodiments of the present disclosure, the changing of the first image may include at least one of reducing a resolution about at least one part of the first image, performing an interpolation about the at least one part of the first image, and performing sampling about the at least one part of the first image.

According to various embodiments of the present disclosure, the extracting of the at least one dominant color may include extracting at least one color which is the most used color included in the at least one partial area of the changed first image as the at least one dominant color.

According to various embodiments of the present disclosure, the extracting of the at least one dominant color may include extracting at least one color which is the most used color included in at least an edge of the at least one partial area of the changed first image as the at least one dominant color.

According to various embodiments of the present disclosure, the performing of the gradient may further include performing a change of at least one of a saturation and a brightness of at least one first dominant color of a first area of the changed first image or at least one second dominant color of a second area of the changed first image when a difference in hue between the at least one first dominant color and the at least one second dominant color is within a designated range, and performing a gradient based on at least one of the changed at least one first dominant color and the changed at least one second dominant color.

According to various embodiments of the present disclosure, the displaying of the second image on the at least one part of the display may further include outputting image data corresponding to at least one partial area of the second image as at least one part of a display object to be displayed on the at least one partial area of the second image when outputting the display object.

According to various embodiments of the present disclosure, the displaying of the second image on the at least one part of the display may further include analyzing first image data corresponding to at least one partial area of the second image and second image data of a display object when outputting the display object to be displayed on the at least one partial area of the second image, changing at least one of the first image data and the second image data when difference values between color parameters of the first image data and color parameters of the second image data are within a designated range, and outputting at least one of the changed first image data and the changed second image data as at least one part of the display object, wherein the color parameters include hue, saturation, and brightness.

According to various embodiments of the present disclosure, an image data processing method may further include designating an image selected by one of a user and setting information of a platform or an application as the first image.

According to various embodiments of the present disclosure, the displaying of the second image on the at least one part of the display may further include displaying the second image on an area when outputting a display object which is touchable and represents information on the area.

According to various embodiments of the present disclosure, a method for processing image data is provided. The method includes generating a second image that includes a first image stored in the memory and a peripheral area that encompasses at least one part of the first image, performing a first gradient in a third area of the peripheral area adjacent to a first area of the first image based on a first dominant color of the first area, performing a second gradient in a fourth area of the peripheral area adjacent to a second area of the first image based on a second dominant color of the second area, and displaying the second image, in which the first gradient and the second gradient are performed, on at least one part of a display.

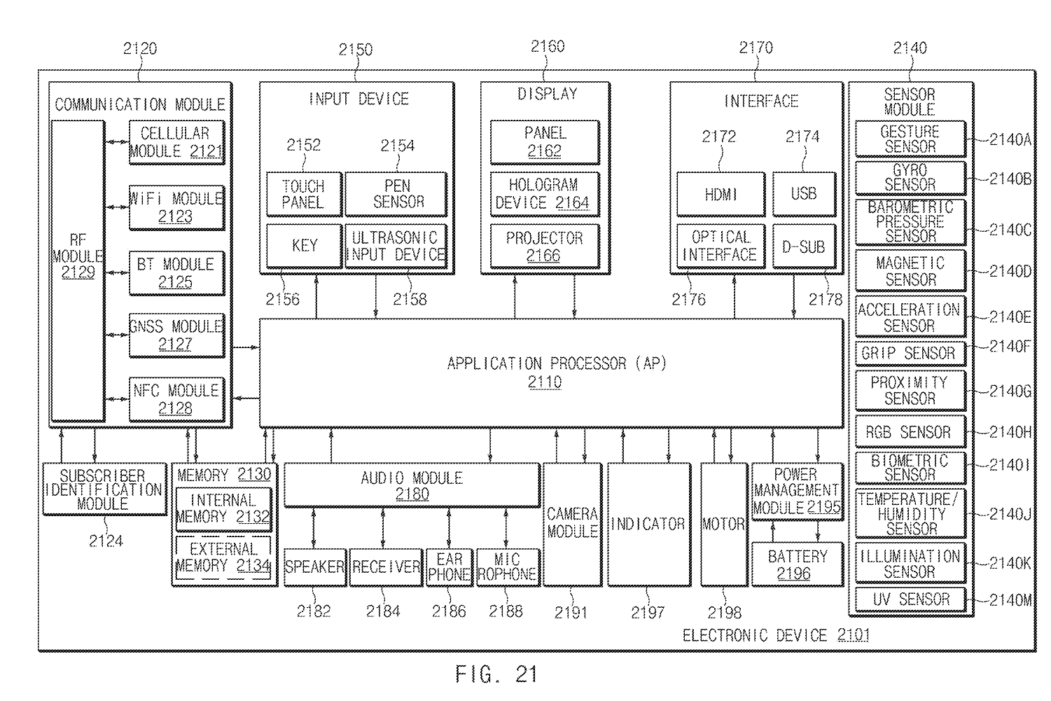

FIG. 21 is a block diagram illustrating an electronic device 2101 according to various embodiments of the present disclosure. The electronic device 2101 may include, for example, all or a part of the electronic device 101 illustrated in FIG. 1. The electronic device 2101 may include one or more processors (e.g., an AP) 2110, a communication module 2120, a subscriber identification module 2124, a memory 2130, a sensor module 2140, an input device 2150, a display 2160, an interface 2170, an audio module 2180, a camera module 2191, a power management module 2195, a battery 2196, an indicator 2197, and a motor 2198.

Referring to FIG. 21, the processor 2110 may drive an OS or an application program to control a plurality of hardware or software elements connected to the processor 2110 and may process and compute a variety of data. The processor 2110 may be implemented with a system on chip (SoC), for example. According to an embodiment of the present disclosure, the processor 2110 may further include a graphic processing unit (GPU) and/or an image signal processor (ISP). The processor 2110 may include at least a part (e.g., a cellular module 2121) of elements illustrated in FIG. 21. The processor 2110 may load and process an instruction or data, which is received from at least one of other elements (e.g., a nonvolatile memory) and may store a variety of data in a nonvolatile memory.

The communication module 2120 may be configured the same as or similar to the communication interface 170 of FIG. 1. The communication module 2120 may include the cellular module 2121, a Wi-Fi module 2123, a Bluetooth (BT) module 2125, a GNSS module 2127 (e.g., a GPS module, a GLONASS module, Beidou module, or a Galileo module), a NFC module 2128, and a radio frequency (RF) module 2129.

The cellular module 2121 may provide voice communication, video communication, a character service, an Internet service or the like through a communication network. According to an embodiment of the present disclosure, the cellular module 2121 may perform discrimination and authentication of the electronic device 2101 within a communication network using the subscriber identification module 2124 (e.g., a SIM card), for example. According to an embodiment of the present disclosure, the cellular module 2121 may perform at least a portion of functions that the processor 2110 provides. According to an embodiment of the present disclosure, the cellular module 2121 may include a CP.

Each of the Wi-Fi module 2123, the BT module 2125, the GNSS module 2127, and the NFC module 2128 may include a processor for processing data exchanged through a corresponding module, for example. According to an embodiment of the present disclosure, at least a part (e.g., two or more elements) of the cellular module 2121, the Wi-Fi module 2123, the BT module 2125, the GNSS module 2127, and the NFC module 2128 may be included within one integrated circuit (IC) or an IC package.

The RF module 2129 may transmit and receive, for example, a communication signal (e.g., an RF signal). The RF module 2129 may include, for example, a transceiver, a power amplifier module (PAM), a frequency filter, a low noise amplifier (LNA), an antenna, or the like. According to another embodiment of the present disclosure, at least one of the cellular module 2121, the Wi-Fi module 2123, the BT module 2125, the GNSS module 2127, or the NFC module 2128 may transmit and receive an RF signal through a separate RF module.

The subscriber identification module 2124 may include, for example, a card and/or embedded SIM that includes a subscriber identification module and may include unique identify information (e.g., integrated circuit card identifier (ICCID)) or subscriber information (e.g., international mobile subscriber identity (IMSI)).

The memory 2130 (e.g., the memory 130) may include an internal memory 2132 or an external memory 2134. For example, the internal memory 2132 may include at least one of a volatile memory (e.g., a dynamic random access memory (DRAM), a static RAM (SRAM), or a synchronous DRAM (SDRAM)), a nonvolatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a NAND flash memory, or a NOR flash memory), a hard drive, or a solid state drive (SSD).

The external memory 2134 may include a flash drive, for example, compact flash (CF), secure digital (SD), micro-SD, mini-SD, extreme digital (xD), multimedia card (MMC), a memory stick, or the like. The external memory 2134 may be functionally and/or physically connected with the electronic device 2101 through various interfaces.

The sensor module 2140 may measure, for example, a physical quantity or may detect an operation state of the electronic device 2101. The sensor module 2140 may convert the measured or detected information to an electric signal. The sensor module 2140 may include at least one of a gesture sensor 2140A, a gyro sensor 2140B, a pressure sensor 2140C, a magnetic sensor 2140D, an acceleration sensor 2140E, a grip sensor 2140F, a proximity sensor 2140G, a color sensor 2140H (e.g., red, green, blue (RGB) sensor), a biometric sensor 2140I, a temperature/humidity sensor 2140J, an illumination sensor 2140K, or an ultraviolet (UV) sensor 2140M. Even though not illustrated, additionally or alternatively, the sensor module 2140 may include, for example, an E-nose sensor, an electromyography sensor (EMG) sensor, an electroencephalogram (EEG) sensor, an electrocardiogram (ECG) sensor, an infrared (IR) sensor, an iris sensor, and/or a fingerprint sensor. The sensor module 2140 may further include a control circuit for controlling at least one or more sensors included therein. According to an embodiment of the present disclosure, the electronic device 2101 may further include a processor which is a part of the processor 2110 or independent of the processor 2110 and is configured to control the sensor module 2140. The processor may control the sensor module 2140 while the processor 2110 remains at a sleep state.

The input device 2150 may include, for example, a touch panel 2152, a (digital) pen sensor 2154, a key 2156, or an ultrasonic input unit 2158. The touch panel 2152 may use at least one of capacitive, resistive, infrared and ultrasonic detecting methods. Also, the touch panel 2152 may further include a control circuit. The touch panel 2152 may further include a tactile layer to provide a tactile reaction to a user.

The (digital) pen sensor 2154 may be, for example, a portion of a touch panel or may include an additional sheet for recognition. The key 2156 may include, for example, a physical button, an optical key, a keypad, or the like. The ultrasonic input device 2158 may detect (or sense) an ultrasonic signal, which is generated from an input device, through a microphone (e.g., a microphone 2188) and may check data corresponding to the detected ultrasonic signal.

The display 2160 (e.g., the display 160) may include a panel 2162, a hologram device 2164, or a projector 2166. The panel 2162 may be configured the same as or similar to the display 160 of FIG. 1. The panel 2162 may be implemented to be flexible, transparent or wearable, for example. The panel 2162 and the touch panel 2152 may be integrated into a single module. The hologram device 2164 may display a stereoscopic image in a space using a light interference phenomenon. The projector 2166 may project light onto a screen so as to display an image. The screen may be arranged inside or outside the electronic device 2101. According to an embodiment of the present disclosure, the display 2160 may further include a control circuit for controlling the panel 2162, the hologram device 2164, or the projector 2166.

The interface 2170 may include, for example, an HDMI 2172, a USB 2174, an optical interface 2176, or a D-subminiature (D-sub) 2178. The interface 2170 may be included, for example, in the communication interface 170 illustrated in FIG. 1. Additionally or alternatively, the interface 2170 may include, for example, a mobile high definition link (MHL) interface, a SD card/multi-media card (MMC) interface, or an infrared data association (IrDA) standard interface.

The audio module 2180 may convert a sound and an electrical signal in dual directions. At least a part of the audio module 2180 may be included, for example, in the I/O interface 150 illustrated in FIG. 1. The audio module 2180 may process, for example, sound information that is input or output through a speaker 2182, a receiver 2184, an earphone 2186, or a microphone 2188.

The camera module 2191 for shooting a still image or a video may include, for example, at least one image sensor (e.g., a front sensor or a rear sensor), a lens, an ISP, or a flash (e.g., an LED or a xenon lamp).

The power management module 2195 may manage, for example, power of the electronic device 2101. According to an embodiment of the present disclosure, a power management integrated circuit (PMIC) a charger IC, or a battery or fuel gauge may be included in the power management module 2195. The PMIC may have a wired charging method and/or a wireless charging method. The wireless charging method may include, for example, a magnetic resonance method, a magnetic induction method or an electromagnetic method and may further include an additional circuit, for example, a coil loop, a resonant circuit, a rectifier, or the like. The battery gauge may measure, for example, a remaining capacity of the battery 2196 and a voltage, current or temperature thereof while the battery is charged. The battery 2196 may include, for example, a rechargeable battery or a solar battery.

The indicator 2197 may display a specific state of the electronic device 2101 or a part thereof (e.g., the processor 2110), such as a booting state, a message state, a charging state, and the like. The motor 2198 may convert an electrical signal into a mechanical vibration and may generate a vibration effect, a haptic effect, or the like. Even though not illustrated, a processing device (e.g., a GPU) for supporting a mobile TV may be included in the electronic device 2101. The processing device for supporting a mobile TV may process media data according to the standards of digital multimedia broadcasting (DMB), digital video broadcasting (DVB), MediaFlo™, or the like.

Each of the above-mentioned elements may be configured with one or more components, and the names of the elements may be changed according to the type of the electronic device. The electronic device according to various embodiments may include at least one of the above-mentioned elements, and some elements may be omitted or other additional elements may be added. Furthermore, some of the elements of the electronic device according to various embodiments may be combined with each other so as to form one entity, so that the functions of the elements may be performed in the same manner as before the combination.

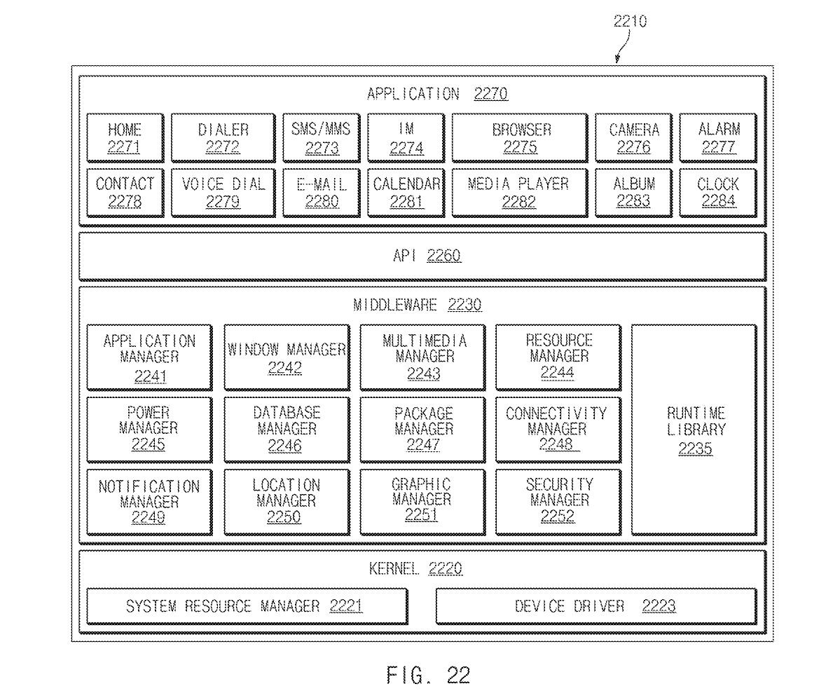

FIG. 22 is a block diagram of a program module according to various embodiments of the present disclosure. According to an embodiment of the present disclosure, a program module 2210 (e.g., the program 140) may include an OS to control resources associated with an electronic device (e.g., the electronic device 101) and/or diverse applications (e.g., the application program 147) driven on the OS. The OS may be, for example, android, iOS, windows, symbian, tizen, or bada.

Referring to FIG. 22, the program module 2210 may include a kernel 2220, a middleware 2230, an API 2260, and/or an application 2270. At least a part of the program module 2210 may be preloaded on an electronic device or may be downloadable from an external electronic device (e.g., the external electronic devices 102 and 104, the server 106, and the like).

The kernel 2220 (e.g., the kernel 141) may include, for example, a system resource manager 2221 and/or a device driver 2223. The system resource manager 2221 may perform control, allocation, or retrieval of system resources. According to an embodiment of the present disclosure, the system resource manager 2221 may include a process managing part, a memory managing part, or a file system managing part. The device driver 2223 may include, for example, a display driver, a camera driver, a Bluetooth driver, a common memory driver, an USB driver, a keypad driver, a Wi-Fi driver, an audio driver, or an inter-process communication (IPC) driver.

The middleware 2230 may provide, for example, a function which the application 2270 needs in common or may provide diverse functions to the application 2270 through the API 2260 to allow the application 2270 to efficiently use limited system resources of the electronic device. According to an embodiment of the present disclosure, the middleware 2230 (e.g., the middleware 143) may include at least one of a runtime library 2235, an application manager 2241, a window manager 2242, a multimedia manager 2243, a resource manager 2244, a power manager 2245, a database manager 2246, a package manager 2247, a connectivity manager 2248, a notification manager 2249, a location manager 2250, a graphic manager 2251, and a security manager 2252.

The runtime library 2235 may include, for example, a library module which is used by a compiler to add a new function through a programming language while the application 2270 is being executed. The runtime library 2235 may perform I/O management, memory management, or capacities about arithmetic functions.

The application manager 2241 may manage, for example, a life cycle of at least one application of the application 2270. The window manager 2242 may manage a GUI resource which is used in a screen. The multimedia manager 2243 may identify a format necessary for playing diverse media files, and may perform encoding or decoding of media files by using a codec suitable for the format. The resource manager 2244 may manage resources such as a storage space, memory, or source code of at least one application of the application 2270.

The power manager 2245 may operate, for example, with a basic input/output system (BIOS) to manage a battery or power and may provide power information for an operation of an electronic device. The database manager 2246 may generate, search for, or modify database which is to be used in at least one application of the application 2270. The package manager 2247 may install or update an application which is distributed in the form of a package file.

The connectivity manager 2248 may manage, for example, wireless connection such as Wi-Fi or Bluetooth. The notification manager 2249 may display or notify an event such as arrival message, promise, or proximity notification in a mode that does not disturb a user. The location manager 2250 may manage location information of an electronic device. The graphic manager 2251 may manage a graphic effect that is provided to a user or manage a user interface relevant thereto. The security manager 2252 may provide a general security function necessary for system security or user authentication. According to an embodiment of the present disclosure, in the case where an electronic device (e.g., the electronic device 101) includes a telephony function, the middleware 2230 may further includes a telephony manager for managing a voice or video call function of the electronic device.

The middleware 2230 may include a middleware module that combines diverse functions of the above-described elements. The middleware 2230 may provide a module specialized to each OS kind to provide differentiated functions. In addition, the middleware 2230 may remove a part of the preexisting elements, dynamically, or may add new elements thereto.

The API 2260 (e.g., the API 145) may be, for example, a set of programming functions and may be provided with a configuration which is variable depending on an OS. For example, in the case where an OS is the android or the iOS, it may be permissible to provide one API set per platform. In the case where an OS is the tizen, it may be permissible to provide two or more API sets per platform.

The application 2270 (e.g., the application program 147) may include, for example, one or more applications capable of providing functions for a home 2271, a dialer 2272, a short message service (SMS)/multimedia messaging service (MMS) 2273, an instant message (IM) 2274, a browser 2275, a camera 2276, an alarm 2277, a contact 2278, a voice dial 2279, an e-mail 2280, a calendar 2281, a media player 2282, an album 2283, and a clock 2284, or for offering health care (e.g., measuring an exercise quantity or blood sugar) or environment information (e.g., information of barometric pressure, humidity, or temperature).

According to an embodiment of the present disclosure, the application 2270 may include an application (hereinafter referred to as “information exchanging application” for descriptive convenience) to support information exchange between the electronic device (e.g., the electronic device 101) and an external electronic device (e.g., the external electronic device 102 or 104). The information exchanging application may include, for example, a notification relay application for transmitting specific information to the external electronic device, or a device management application for managing the external electronic device.

For example, the notification relay application may include a function of transmitting notification information, which arise from other applications (e.g., applications for SMS/MMS, e-mail, health care, or environmental information), to an external electronic device (e.g., the external electronic device 102 or 104). Additionally, the notification relay application may receive, for example, notification information from an external electronic device and provide the notification information to a user.

The device management application may manage (e.g., install, delete, or update), for example, at least one function (e.g., turn-on/turn-off of an external electronic device itself (or a part of components) or adjustment of brightness (or resolution) of a display) of an external electronic device (e.g., the external electronic device 102 or 104) which communicates with the electronic device, an application running in the external electronic device, or a service (e.g., a call service, a message service, or the like) provided from the external electronic device.

According to an embodiment of the present disclosure, the application 2270 may include an application (e.g., a health care application) which is assigned in accordance with an attribute (e.g., an attribute of a mobile medical device as a kind of electronic device) of an external electronic device (e.g., the external electronic device 102 or 104). According to an embodiment of the present disclosure, the application 2270 may include an application which is received from an external electronic device (e.g., the server 106 or the external electronic device 102 or 104). According to an embodiment of the present disclosure, the application 2270 may include a preloaded application or a third party application which is downloadable from a server. The element titles of the program module 2210 according to the embodiment may be modifiable depending on kinds of OSs.

According to various embodiments of the present disclosure, at least a part of the program module 2210 may be implemented by software, firmware, hardware, or a combination of two or more thereof. At least a portion of the program module 2210 may be implemented (e.g., executed), for example, by the processor (e.g., the processor 2110). At least a portion of the program module 2210 may include, for example, a module, a program, a routine, sets of instructions, or a process for performing one or more functions.

The term “module” used in this disclosure may represent, for example, a unit including one or more combinations of hardware, software and firmware. For example, the term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” may include at least one of an application-specific IC (ASIC) chip, a field-programmable gate array (FPGA), and a programmable-logic device for performing some operations, which are known or will be developed.

At least a portion of an apparatus (e.g., modules or functions thereof) or a method (e.g., operations) according to various embodiments may be, for example, implemented by instructions stored in a computer-readable storage media in the form of a program module. The instruction, when executed by a processor (e.g., the processor 120), may cause the one or more processors to perform a function corresponding to the instruction. The computer-readable storage media, for example, may be the memory 130.

The computer-readable storage media may include a hard disk, a floppy disk, a magnetic media (e.g., a magnetic tape), an optical media (e.g., a compact disc-ROM (CD-ROM) and a DVD), a magneto-optical media (e.g., a floptical disk), and hardware devices (e.g., a ROM, a RAM, or a flash memory). Also, a program instruction may include not only a mechanical code such as things generated by a compiler but also a high-level language code executable on a computer using an interpreter. The above-mentioned hardware devices may be configured to operate as one or more software modules to perform operations according to various embodiments of the present disclosure, and vice versa.

According to various embodiments of the present disclosure, the visibility of a reference image with regard to a gradient image may be raised by extracting a dominant color excluding colors of lower usage based on color clustering degree with regard to the reference image.

According to various embodiments of the present disclosure, the diversity in color representation of a gradient image may be raised by dividing the reference image into a plurality of areas, extracting a dominant color of each area, and applying a gradient using a plurality of the extracted dominant colors.

According to various embodiments of the present disclosure, it may be possible to emphasize features for each area of a reference image by applying a designated gradient effect using dominant colors extracted for respective areas and to achieve a visual effect through this method.

Furthermore, according to various embodiments of the present disclosure, in the case where the extracted dominant colors are similar, it may be possible to increase visibility of a color by modifying the dominant colors.

Modules or program modules according to various embodiments may include at least one or more of the above-mentioned elements, some of the above-mentioned elements may be omitted, or other additional elements may be further included therein. Operations executed by modules, program modules, or other elements according to various embodiments may be executed by a successive method, a parallel method, a repeated method, or a heuristic method. Also, a part of operations may be executed in different sequences, omitted, or other operations may be added.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a display;
a processor electrically connected with the display; and
a memory electrically connected with the processor,
wherein the memory comprises instructions, which, when executed by the processor, cause the processor to:
change a first image such that the first image comprising a first amount of data is changed to comprise a second amount of data that is less than the first amount of data,
extract at least one dominant color of at least one partial area of the changed first image,
perform a gradient in the at least one partial area of the changed first image based on the extracted at least one dominant color, and
control the display to display a second image comprising the at least one partial area to which the gradient is applied on at least one part of the display.

2. The electronic device of claim 1, wherein the instructions further cause the processor to change the first image by performing at least one of a resolution reduction, interpolation, and sampling with respect to at least one part of the first image.

3. The electronic device of claim 1, wherein the instructions further cause the processor to extract at least one color which comprises a most used color included in the at least one partial area of the changed first image as the at least one dominant color.

4. The electronic device of claim 1, wherein the instructions further cause the processor to extract at least one color which comprises a most used color included in at least one edge of the at least one partial area of the changed first image as the at least one dominant color.

5. The electronic device of claim 1, wherein the instructions further cause the processor to:
change at least one of a saturation and a brightness of at least one first dominant color of a first area of the changed first image or at least one second dominant color of a second area of the changed first image when a difference in hue between the at least one first dominant color and the at least one second dominant color is within a designated range, and
perform a gradient based on at least one of the changed at least one first dominant color and the changed at least one second dominant color.

6. The electronic device of claim 1, wherein the instructions further cause the processor to output image data corresponding to at least one partial area of the second image as at least one part of a display object to be displayed on the at least one partial area of the second image when outputting the display object.

7. The electronic device of claim 1, wherein the instructions further cause the processor to:
analyze first image data corresponding to at least one partial area of the second image and second image data of a display object when outputting the display object to be displayed on the at least one partial area of the second image,
change at least one of the first image data and the second image data when difference values between color parameters of the first image data and color parameters of the second image data are within a designated range, and
output at least one of the changed first image data and the changed second image data as at least one part of the display object,
wherein the color parameters include hue, saturation, and brightness.

8. The electronic device of claim 1, wherein the instructions further cause the processor to:
modify the second image based on at least one of a size and a shape of the at least one part of the display, and
display the modified second image on the at least one part of the display.

9. The electronic device of claim 1, wherein the instructions further cause the processor to designate an image selected by one of a user and setting information of a platform or an application as the first image.

10. The electronic device of claim 1, wherein the instructions further cause the processor to display the second image on an area when outputting a display object which is touchable and represents information on the area.

11. An electronic device comprising:
a display;
a processor electrically connected with the display; and
a memory electrically connected with the processor,
wherein the memory comprises instructions, which, when executed by the processor, instruct the processor to:
generate a second image that comprises a first image stored in the memory and a peripheral area that encompasses at least a part of the first image,
perform a first gradient in a third area of the peripheral area adjacent to a first area of the first image based on a first dominant color of the first area,
perform a second gradient in a fourth area of the peripheral area adjacent to a second area of the first image based on a second dominant color of the second area, and
display the second image, in which the first gradient and the second gradient are performed, on at least a part of the display.

12. A method for processing image data of an electronic device, the method comprising:
changing a first image such that the first image comprising a first amount of data is changed to comprise a second amount of data that is less than the first amount of data,
extracting at least one dominant color of at least one partial area of the changed first image,
performing a gradient in the at least one partial area of the changed first image based on the extracted at least one dominant color, and
displaying a second image comprising the at least one partial area to which the gradient is applied on at least one part of a display.

13. The method of claim 12, wherein the changing of the first image comprises at least one of:
reducing a resolution about at least one part of the first image,
performing an interpolation about the at least one part of the first image, and
performing sampling about the at least one part of the first image.

14. The method of claim 12, wherein the extracting of the at least one dominant color comprises:
extracting at least one color which comprises a most used color included in the at least one partial area of the changed first image as the at least one dominant color.

15. The method of claim 12, wherein the extracting of the at least one dominant color comprises:
extracting at least one color which comprises a most used color included in at least one edge of the at least one partial area of the changed first image as the at least one dominant color.

16. The method of claim 12, wherein the performing of the gradient further comprises:
performing a change of at least one of a saturation and a brightness of at least one first dominant color of a first area of the changed first image or at least one second dominant color of a second area of the changed first image when a difference in hue between the at least one first dominant color and the at least one second dominant color is within a designated range, and
performing a gradient based on at least one of the changed at least one first dominant color and the changed at least one second dominant color.

17. The method of claim 12, wherein the displaying of the second image on the at least one part of the display further comprises:
outputting image data corresponding to at least one partial area of the second image as at least one part of a display object to be displayed on the at least one partial area of the second image when outputting the display object.

18. The method of claim 12, wherein the displaying of the second image on the at least one part of the display further comprises:
analyzing first image data corresponding to at least one partial area of the second image and second image data of a display object when outputting the display object to be displayed on the at least one partial area of the second image,
changing at least one of the first image data and the second image data when difference values between color parameters of the first image data and color parameters of the second image data are within a designated range, and
outputting at least one of the changed first image data and the changed second image data as at least one part of the display object,
wherein the color parameters include hue, saturation, and brightness.

19. The method of claim 12, further comprising:
designating an image selected by one of a user and setting information of a platform or an application as the first image.

20. The method of claim 12, wherein the displaying of the second image on the at least one part of the display further comprises:
displaying the second image on an area when outputting a display object which is touchable and represents information on the area.
